(19) United States
(12) Patent Application Publication
(10) Pub. No.: US 2013/0321816 A1
(43) Pub. Date: Dec. 5, 2013

(54) FULLY INTEGRATED COMPLEMENTARY METAL OXIDE SEMICONDUCTOR (CMOS) FOURIER TRANSFORM INFRARED (FTIR) SPECTROMETER AND RAMAN SPECTROMETER

(71) Applicants: Yonathan Dattner, Calgary (CA); Orly Yadid-Pecht, Calgary (CA)

(72) Inventors: Yonathan Dattner, Calgary (CA); Orly Yadid-Pecht, Calgary (CA)

(73) Assignee: LUXMUX TECHNOLOGY CORPORATION, Calgary, AB (CA)

(21) Appl. No.: 13/985,550

(22) PCT Filed: Feb. 14, 2012
(86) PCT No.: PCT/CA2012/000137

§ 371 Date: Aug. 14, 2013

Related U.S. Application Data
(60) Provisional application No. 61/442,979, filed on Feb. 15, 2011.

(51) Int. Cl. G01J 3/45

(52) U.S. Cl. CPC G01J 3/45
USPC 356/451

(57) ABSTRACT

A Fourier Transform Infrared (FTIR) Spectrometer integrated in a CMOS technology on a Silicon-on-Insulator (SOI) wafer is disclosed. The present invention is fully integrated into a compact, miniaturized, low cost, CMOS fabrication compatible chip. The present invention may be operated in various infrared regions ranging from 1.1 μm to 15 μm or it can cover the full spectrum from 1.1 μm to 15 μm all at once.

The CMOS-FTIR spectrometer disclosed herein has high spectral resolution, no movable parts, no lenses, is compact, not prone to damage in harsh external conditions and can be fabricated with a standard CMOS technology, allowing the mass production of FTIR spectrometers. The fully integrated CMOS-FTIR spectrometer is suitable for battery operation; any and all functionality can be integrated on a chip with standard CMOS technology. The disclosed invention for the FTIR spectrometer may also be adapted for a CMOS-Raman spectrometer.

### FIELD OF ART

The present invention relates to the field of spectrometry.

### BACKGROUND

Complementary Metal Oxide Semiconductor (CMOS) technology is a mature fabrication technology and has well established techniques and foundries allowing mass production of products for a relatively low cost. Traditionally Fourier Transform Infrared (FTIR) spectrometers have been bulky, incorporating many optical devices, lenses and movable parts thereby cost has been high and the device is only accessible in a laboratory environment. Recently miniaturized FTIR spectrometers for the field have been disclosed, some incorporating Microelectomechanical Systems (MEMS) devices, some using optical fibers, but these systems are still the size of a small box, cost is still relatively high, and they all still have easily damaged optics, lenses and a moveable mirror. A large number of applications exist for FTIR spectroscopy in the near, mid and long infrared regions, i.e. 1.1 μm-15 μm. These infrared regions provide distinguishing signatures for many organic and inorganic materials. These so called “fingerprint regions” are useful in a variety of applications including analytical chemistry, biochemistry, materials research, environmental sensing, chemical bio-sensing, condition-based maintenance and medical diagnosis.

FTIR spectroscopy is perhaps the most powerful tool for identifying types of chemical bonds. Traditionally FTIR spectrometers are large bench level devices, expensive (a few hundreds of thousands of dollars) and are only accessible in labs and research facilities. Recently smaller FTIR spectrometers have been introduced, but they are still a bulky size and expensive.

All these spectrometers incorporate some sort of optics, lenses and movable parts; all are prone to displacement and malfunction in a field environment. Controlling the movable mirror's velocity requires advanced methods including lasers to control the actuators, all adding a degree of complexity and cost to the classical FTIR spectrometer. To the best of our knowledge there is still no invention disclosing an FTIR spectrometer with no moving parts, low cost, miniature and low power. In addition to an existing FTIR spectroscopy market, such a device will produce a new market for a variety of consumer/commercial and industrial based products.

### SUMMARY OF INVENTION

A spectrometer is provided in one embodiment of the invention, comprising: a broadband infrared signal, divided into wavelength spans so that each wavelength span only propagates in its fundamental mode, with means to generate an interferogram via modulation in silicon waveguides

The spectrometer is provided in another embodiment with a broadband infrared source for the signal integrated on the same integrated circuit as the spectrometer.

The spectrometer may be built such that the generation of the interferogram via modulation is based on the thermo-optic effect of silicon; alternatively, the generation of the interferogram via modulation is based on the plasma dispersion effect of silicon (Free Carrier Absorption)

The spectrometer may be supplied with means to sense temperature to obtain high spectral accuracy.

The spectrometer may in another embodiment have a sample interface integrated on chip using ATR in silicon waveguides in which the light does not leave the waveguide and is only diffracted or coupled out of the waveguide when reaching an infrared detector.

The spectrometer in an embodiment may be provided with a sample interface integrated on chip for external reflectance utilizing a diffraction grating to modulate the angle of light.

The spectrometer in an embodiment may be provided with a free-standing thermal detector microbolometer integrated on the same integrated circuit as the spectrometer.

The spectrometer can be provided with circuitry implementing an algorithm involving the ADC to incorporate the DDA's sensitivity enhancement.

The spectrometer can be an integrated CMOS-FTIR spectrometer.

The spectrometer can be a CMOS-Raman Spectrometer.

In various embodiments, the spectrometer can be made useful for longer wavelengths, up to 11 μm by using silicon nitride, and up to 15 μm by using various materials transparent to infrared wave lengths up to 15 μm.

The present invention may provide an apparatus comprising: a spectrometer with a broadband signal divided into N wavelength spans Δλᵢ, i=1, . . . N so that each wavelength span only propagates in its fundamental mode; an integrated broadband infrared source on silicon on insulator wafer; an interferogram generated via modulation in silicon waveguides based on the thermo-optic effect or plasma dispersion effect of silicon; high spectral accuracy based on sensing the temperature when modulating with the thermo-optic effect in silicon; a sample interface using attenuated total reflectance (ATR) in silicon waveguides in which the light does not leave the waveguide and is only diffracted or coupled out of the waveguides when reaching the infrared detector; a sample interface for external reflectance utilizing a diffraction grating to modulate the angle of light; a free-standing thermal detector microbolometer; an algorithm involving the analog to digital converter (ADC) to incorporate the Differential Difference Amplifier's (DDA) sensitivity enhancement; an expansion of the spectrometer to longer wavelengths, up to 11 μm with silicon nitride, (see FIG. 23), and up to 15 μm by using various materials transparent to infrared wave lengths up to 15 μm; and an integrated CMOS-FTIR spectrometer and CMOS-Raman Spectrometer.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is a schematic block diagram for the integrated CMOS-FTIR spectrometer developed on a SOI wafer;

FIG. 2 is a cross-section view of a schematic of the fabrication layers of the Poly-SiC Infrared Emitter on an SOI wafer;

FIG. 3 depicts a Silicon waveguide structure: (a) perspective side-view of the structure; (b) axis and boundary conditions used to solve for the TE and TM modes; (c) 2-Dimensional cross section view of the waveguide used for the first step in the effective refractive index method; (d) is a top view of the waveguide used for the second step in the effective refractive method in which the refractive index of silicon is substituted with the solution from (c);

FIG. 4 depicts the power distribution and effective refractive index for a waveguide 220 nm in height and width of 600 nm at λ₀=1.4 um. The lowest to highest order modes are shown in (a) to (c), respectively;

FIG. 5 depicts a Bragg Gate Filter implemented by varying waveguide widths, thereby changing the effective refractive index;

FIG. 6 depicts a top view of the MZI Interferometer: (a) with a Multi Mode Interference (MMI) coupler; (b) with a Y-branch combiner

FIG. 7 is a graphical depiction of power coupling to the output ports when utilizing a MMI coupler as a function of the phase difference between the two arms of the MZI for a given wavelength; For a Y-branch combiner only the Pout port exists.

FIG. 8 is a cross sectional view for a series of block diagrams depicting the fabrication layers of one arm in the MZI modulated by the thermo-optic effect;

FIG. 9 depicts an MMI coupler;

FIG. 10 depicts the results of a simulation of the MMI when the two inputs (a) are in phase (b) out of phase by π;

FIG. 11 depicts a typical interferogram;

FIG. 12 is a schematic diagram depicting a top view of the sample interface for the ATR method;

FIG. 13 is a schematic diagram depicting a cross-sectional view of the sample interface for the ATR method;

FIG. 14 is a schematic diagram depicting a cross-sectional view of the sample interface for reflectance mode;

FIG. 15 is a schematic diagram depicting the fabrication layers of an uncooled A-Si Microbolometer for the ATR sample interface;

FIG. 16 is a schematic diagram depicting an uncooled A-Si Microbolometer for external reflectance sample interface;

FIG. 17 depicts a DC bias circuit for A-Si detector;

FIG. 18 depicts the symbol of a DDA;

FIG. 19 depicts an example DDA based instrumentation amplifier which is programmable by two external resistors for a gain of (R1+R2)/R1.

FIG. 20 depicts an example expansion of the CMOS-FTIR spectrometer to longer wavelengths, up to 11 μm;

FIG. 21 is a cross section view of disclosed CMOS-Raman spectrometer input waveguide interface; and

FIG. 22 is a schematic diagram of the top view of CMOS-Raman spectrometer top waveguide interface for a certain wavelength span.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details. Further, the drawings provided are not necessarily to scale and in some instances proportions may have been exaggerated in order more clearly to depict certain features. Throughout the drawings, from time to time, similar numbers may be used to reference similar, but not necessarily identical, parts.

To understand the physics that govern Fourier Transform Infrared (FTIR) spectroscopy a basic understanding of the quantum theory of molecules is explained. Molecular bonds vibrate at various frequencies depending on the elements and type of bonds. For any given bond, there are several specific frequencies at which it can vibrate. Using the laws in quantum mechanics, these frequencies correspond to the ground state and several excited states. One way to cause the frequency of a molecular vibration to increase is to excite the bond by having it absorb light energy. For any given transition between two states the light energy, determined by the wavelength must exactly equal the difference in the energy between the two states. The difference in energy states is equal to the energy of light absorbed, as shown in

Eᵢ−Eᵢ₋₁=hc/l (1)

where Eᵢ is the energy of state i (usually the first excited state, i.e. E₁), Eᵢ₋₁ corresponds to the energy of state i−1(usually the ground state, i.e. E₀), h is Planks constant, c is the speed of light in vacuum and l is the wavelength of light. The energy corresponding to these transitions between molecular vibrational states is generally 1-10 kilocalories/mole, which corresponds to the infrared portion of the electromagnetic spectrum.

An FTIR spectrometer analyzes infrared light by wavelength components and intensities. An interferometric spectrometer records the interference pattern generated by all wavelength components at once and mathematically converts the interference pattern, known as the “interferogram”, into a spectrum. A well known interferometer is the Michelson Interferometer, in which a movable mirror causes a path distance between two coherent beams and the interference pattern is a function of the mirror's displacement. Other components of an FTIR spectrometer are a broadband infrared light source, usually a globar, an infrared detector, an analog readout circuit, analog to digital conversion (ADC), a microprocessor for Fourier transform and a memory storing saved spectrums of different compounds. The disclosed invention performs all the tasks of the traditional FTIR spectrometer, with increased spectral resolution, accuracy no movable parts, no lenses, no optics with the whole device integrated onto a CMOS compatible fabrication chip developed on a Silicon-on-Insulator (SOI) wafer.

The Silicon-on-Insulator (SOI) technology refers to the use of a layered silicon-insulator-silicon substrate. The insulator commonly used is silicon dioxide (SiO2) and the technology has many advantages in both photonics and electronics. In photonics, the high refractive index variation between the silicon (n˜3.5) and the SiO2 (n˜1.5), allows the development of well guided waveguides based on total internal reflection. On the electronics side, low parasitic capacitance due to isolation from the bulk silicon reduces power consumption. In addition SOI designs are resistive to latchup due to complete isolation of the n- and p-well structures. For these reasons the use of an SOI wafer may be an applicable technology for both photonics and the CMOS electronics.

Complementary Metal Oxide Semiconductor (CMOS) is basically a class of integrated circuits, and is used in a range of applications with digital logic circuits such as microprocessors, microcontrollers, static Random Access Memory (RAM), and many more. It is also used in applications with analog circuits, such as in data converters and image sensors. There are quite a few advantages that the CMOS technology has to offer. One of the main advantages is that CMOS technology, which makes it the most commonly-used technology for digital circuits today, enables chips that are small in size to have features like high operating speeds and efficient usage of energy. In addition, devices using CMOS technology have a high degree of noise immunity and well established foundries and techniques exist for CMOS fabrication.

The CMOS-FTIR spectrometer as disclosed herein has all the components of the classical FTIR spectrometer fully integrated into a compact, miniaturized, low cost, CMOS fabrication compatible chip. The disclosed CMOS-FTIR spectrometer can be operated in the short and mid infrared regions, i.e. from 1.4 μm to 8 μm, with a possible extension to the long infrared regions, i.e. 8 μm to 15 μm. The main limitation for working the long infrared region is that Silicon Dioxide (SiO2) is not transparent in this region. To overcome this limitation a different material can be used instead which is transparent up to 15 μm. The details for a CMOS-FTIR spectrometer and CMOS-Raman Spectrometer operation will be discussed herein below.

### I. CMOS-FTIR SPECTROMETER AND CMOS-RAMAN SPECTROMETER ARCHITECTURE

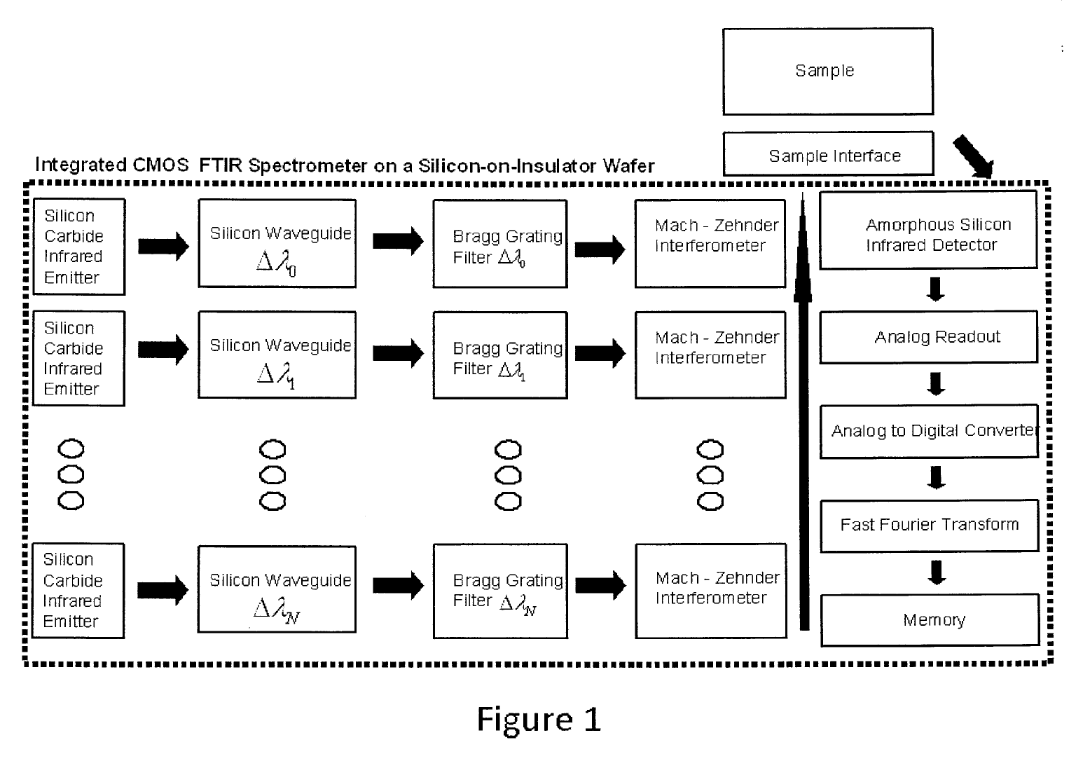

The main building blocks of the integrated CMOS-FTIR spectrometer on an SOI wafer are shown in FIG. 1. Initially, as an example for an infrared emitter (other infrared emitters can be used) made of Silicon Carbide (SIC), which will be discussed in detail in section II, emits broadband infrared radiation. Each SIC infrared source works independently and one possibility with the case of one infrared detector only one source is on at a time. Alternatively, the infrared sources can work in parallel in the case of N infrared detectors. The light can be coupled into the waveguide via diffraction. The diffraction gratings will be discussed more in detail in Section II. The advantage of the diffraction grating is that it acts as a wavelength filter eliminating the need for filters later on in the optical path. The filter is important to maintain single mode operation within the desired wavelength span. Alternatively the light can be edge coupled straight into the waveguide and a filter can be placed later in the optical path.

It is crucial for the infrared light traveling in the waveguides to be single mode; otherwise it would be impossible to distinguish between the modes in the interferometer. For a broadband source and with only a single waveguide dimension, it is very difficult to support all wavelengths and allow only a single mode to propagate. For this reason there are 1, . . . , N initial waveguides, from this point forward depicted as Δλ₀, Δλ₁, . . . , Δλ_{N} respectively, each supporting only the single fundamental mode for a wavelength span, Δλᵢ, i=1, . . . , N.

Each initial waveguide will have different dimensions, width and height, to support its wavelength span which guides only the fundamental mode (higher order modes will not propagate in the waveguide). As an example Δλ₀ will support wavelengths ranging from 1.4 μm-1.9 μm with waveguide dimensions of 600 nm width and 220 nm height. It should be noted that as the wavelengths increase the waveguides dimensions also increase.

Spectral resolution in the classic FTIR spectrometer is mainly determined by the maximum distance the mirror can move and may also be limited by mirror tilt. Intuitively this can be understood that for two close wavelengths to be distinguished the optical path difference must be large enough for the waves to have a 2π phase difference, i.e. in classical FTIR spectrometers the mirrors must move larger distances to achieve higher the spectral resolution. In the disclosed invention the wavelength span of infrared light being modulated is controlled with the waveguides dimensions and wavelength filter. A few examples for filters may be the Diffraction Grating on the input, a Bragg Gating Filter (BGF) or a photonic hole lattice. The infrared light in each span must remain single mode for every wavelength in that span. To achieve this the filter should usually reflect the shorter wavelengths that don't belong to that span because the larger wavelengths that don't belong won't propagate due to the wavelength dimensions. Some possible filter configurations such as the diffraction grating, BGF and photonic holes will be discussed more in detail in Section III.

Each wavelength span will independently enter its respective Mach-Zehnder Interferometer (MZI) which consists of a Y-branch splitter, modulation via the thermo-optic effect or via free carrier absorption, and a multi-mode interference (MMI) coupler. Alternatively a Y-branch combiner can be used instead of the MMI coupler. The Y-branch splitter will split the light 50/50 into the two arms of the MZI, a phase difference will be introduced between two arms with a voltage applied either by the thermo-optic effect in which the voltage changes the temperature of the waveguide or via the free carrier absorption in which the waveguide consists of a reverse biased diode. Either of the two methods can be used for modulation and each has its advantages and disadvantages which will be discussed more in detail in section IV. The MMI coupler recombines the light in the MZI. Depending on the phase difference between the two arms of the MZI, the light gets coupled to its relative exit port. The MMI coupler is based on self imaging and a detailed discussion will be given in section IV. Alternatively the Y-combiner may be used to recombine the light and the in-phase portion will continue to propagate in the waveguides while the out of phase portion will scatter out.

FTIR is capable of gas, liquid and solid sample analysis, making it a powerful tool for a variety of applications. Many sample interfaces can be incorporated in this invention; a method for Attenuated Total Reflectance (ATR) and external reflectance are disclosed. In the ATR method the wave traveling in the waveguide has an evanescent wave component in order to satisfy the boundary condition. The evanescent wave penetrates into the sample and from the absorption of the evanescent wave the optical intensity in the waveguide decreases per wavelength absorbed. For external reflectance, different angles of light can be designed to exit the chip by diffraction to the sample. Sample interfaces will be discussed more in detail in section V.

Any infrared detector may be used with the disclosed invention and as an example the uncooled microbolometer infrared detector is based on thermal sensing and incorporates amorphous silicon (A-Si) as the temperature sensitive material is presented. A-Si has low noise properties, high Temperature Coefficient of Resistance (TCR) and can be prepared with a range of electrical resistivities to meet the CMOS-FTIR spectrometer's resistance specifications. The infrared detector disclosed may utilize a porous gold black absorbing layer and a thin titanium layer (instead of aluminum) which may enhance sensitivity by lowering the thermal conductance of the pads. A more detailed discussion of the figures of merit, fabrication and materials used for the infrared detector will be discussed in section VI.

As an example temperature changes leading to resistive changes in the A-Si can be sensed using a differential difference amplifier (DDA) in the analog readout circuit. The DDA can accurately sense the difference in resistance (voltage) of the detector from the previous reading and amplify this value by a factor greater than 1, thereby increasing the signal-to-noise ratio (SNR) and the sensitivity of the FTIR spectrometer. The DDA will be discussed more in detail in section VII. Alternatively any analog chain sensing the resistance changes in the A-Si may be used.

The main advantage of the CMOS FTIR spectrometer is that the whole system is integrated in a CMOS process, therefore standard analog-to-digital converters (ADC), Fast-Fourier transform (FFT) algorithms and memory architectures, which are well established in the industry, can easily be integrated in the compact CMOS-FTIR spectrometer. In addition, any computational needs, functions or designs can easily be integrated into the chip using standard CMOS techniques.

Table 1 depicts the thermal conductivity and refractive index of some materials that will be used throughout the text. These materials are CMOS compatible and are used frequently in the semiconductor industry. Thermal conductivity is the measure of the material's ability to conduct heat. This is an important parameter for a miniaturized CMOS-FTIR spectrometer because thermal distribution needs to be carefully controlled and isolated for most of the device. The whole chip and crucial components can be cooled using common thermoelectric cooling techniques.

TABLE 1
Thermal Conductivity and refractive indexes of materials commonly
used in semiconductors

| | Thermal Conductivity | Refractive index n at |
|---|---|---|
| Material | k [W · m⁻¹ · K⁻¹] | λ = 1.4 um |
| Silicon (Si) | 150 | 3.5 |
| Silicon Dioxide (SiO2) | 1.4 | 1.5 |
| Silicon Nitride (Si3N4) | 32 | 1.8-2.2 |
| Amorphous Silicon (a-Si) | 133 | 4.2 |
| Polyimide (PI) | 0.4 | 1.6 |
| Titanium | 21.9 | 3.8 |
| Aluminum | 237 | 1.3 |
| Barium Fluoride (BaF2) | 12 | 1.4 |
| Potassium Bromide | 4.8 | 1.5 |
| (KBr) | | |
| Air | 0.025 | 1 |

Raman spectroscopy is a technique used to study the vibrational, rotational and other low frequency modes in system. It is similar to the FTIR spectroscopy, yields the same results, but provides complementary information. The main difference in a Raman spectrometer is that light from a monochromatic source is used to excite the vibrational and rotational modes in the sample under test. Broadband light emitted from the sample is collected and an interferogram is generated from the Raman scattering. With regards to the disclosed invention, all the components that will be discussed in sections III-IV and sections VI-IX are the same for the disclosed CMOS-Raman spectrometer. The only difference will be in section II in that the broadband source is not needed, just a monochromatic light source and in section V in which case the sample interface for a CMOS-Raman implementation is before the wavelength filter and the interferometer. The differences and the design for the CMOS-Raman spectrometer will be discussed more in detail in section X.

The remainder of this description consists of Section II, which describes the light source fabrication. Section III will disclose the initial waveguide scheme and BGF. In Section IV the MZI interferometer design will be disclosed. Section V will discuss the sample interface. In Section VI the infrared detector is disclosed. In Section VII the analog readout path and the DDA is discussed. Section VIII presents the ADC and digital algorithms used. In section IX, the CMOS-FTIR spectrometer expansion for the long infrared regions is discussed. In Section X the design for the CMOS-Raman spectrometer is disclosed; and lastly in Section XI, the conclusion of this detailed description appears.

### II. SILICON CARBIDE INFRARED EMITTER

Silicon Carbide was one of the first materials in which the phenomenon of electroluminescence was first observed in 1907. As a possibility of an infrared source, this invention introduces a poly-SiC as a resistively heated infrared source. The infrared source is capable of fast thermal cycling under pulsed operation because of the Poly-SiC's high emissivity, high thermal conductivity, and low thermal mass.

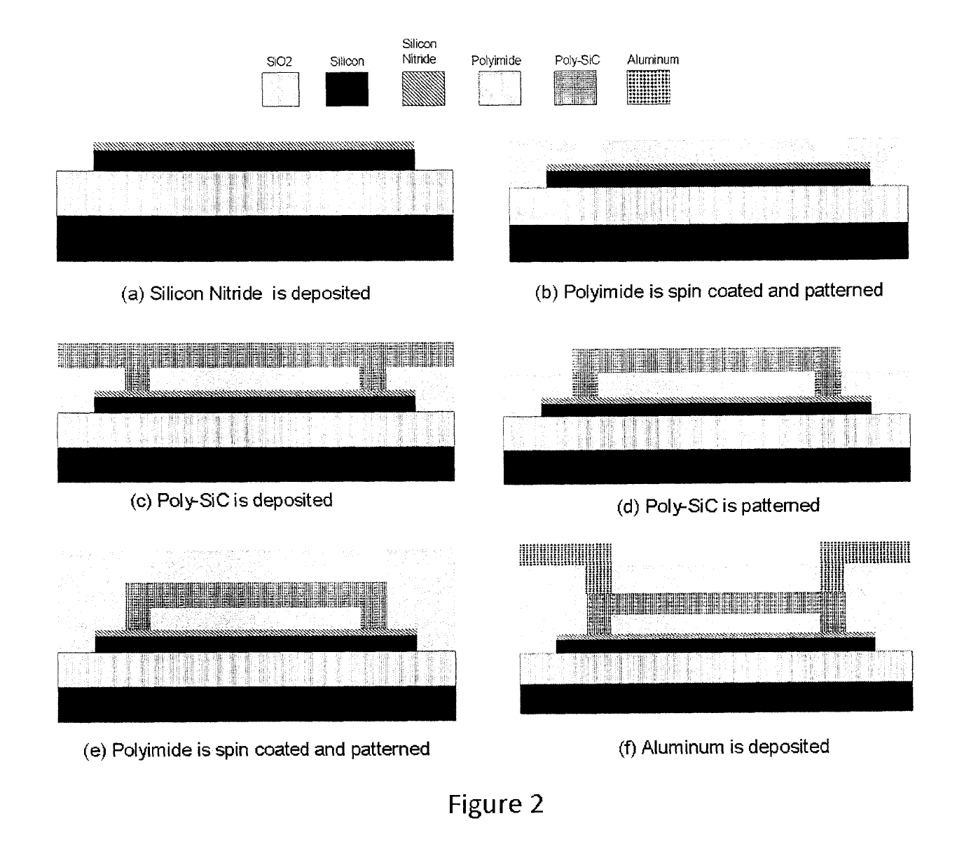

FIG. 2 shows a cross section view of the fabrication layers involved in the Poly-SiC infrared emitter on an SOI wafer. The fabrication steps are only an illustration for conceptual understanding and do not depict the full fabrication flow or sequence. First the silicon is etched away on the sides and in front of the emitter leaving an air gap from the rest of the circuit. Silicon has a high thermal conductivity and it is used as a heat sink to control the flow of heat away from the infrared emitter. Polyimide is a common material used in CMOS circuits and is well known for its low thermal conductivity, very low stress and excellent adherence to silicon. Initially a thin, low stress layer of Silicon Nitride is deposited by low temperature chemical vapor deposition (LPCVD) as shown in (a). Silicon Nitride is used to electrically isolate the silicon from the emitter and it has been shown to have good bonding properties with Poly-SiC. Next the polyimide is spin coated and patterned with anchors for the heat sink connections to the silicon nitride/silicon layer as shown in (b). In (c) a low stress, heavily doped Poly-SiC film is deposited by using LPCVD and patterned to define the emitter using inductively coupled plasma etch and patterned as shown in (d). In (e) another layer of polyimide for thermal insulation is spin coated and patterned, leaving openings for the biasing of the infrared emitter. Lastly in (f) aluminum is deposited at each of the anchor/pads on the sides of the emitter for operation of the infrared source via application of current or voltage. The polyimide can be either removed with microwave plasma ashing to get a free standing structure or can be left as a thermal insulator.

As stated herein above, each wavelength span Δλᵢ, i=1, . . . , N has its own infrared source. Each source can work in parallel if there N infrared detectors are used or alternatively one infrared detector may be used to cover the whole span. In the case of one infrared detector each source is turned on independently, in a timed preprogrammed sequence, to extract the interferogram for its relative wavelength span and is then turned off, at which time the heat will escape through the heat sinks into the isolated silicon away from the rest of the device. One of the advantages of using a separate infrared source for each span is that the operating voltage/temperature can be adjusted to get maximum power intensity for its wavelength span. The well known Stephan-Boltzmann law in (2) states the power emitted per unit area of a black body is directly proportional to the fourth power of its absolute temperature;

j=σT⁴ (2)

where j is the total power radiated per unit area, σ is the Stephan Boltzmann constant (5.67×10⁻⁸[W·m⁻²·K⁻⁴]) and T is the temperature in Kelvin. In addition Wein's displacement law (3) states the wavelength in which the intensity of the radiation emitted by a blackbody is at maximum λₘₐₓ, is a function of the temperature.

$${λ}_{max} = \frac{b}{T} \qquad ( 3 )$$

where b is the Wein's displacement constant (b=2.8977685×10⁻³ [m·K]) The Poly-SiC infrared emitter is not an ideal black body, but as a good approximation can be used as one to derive the operating voltage; using (2) and (3) an optimized operating temperature/voltage can be derived for each infrared emitter separately so that the peak wavelength falls in the wavelength span and so that the temperature is high enough to get the desired emission. When measuring the infrared emission for the poly-SiC source, it is good practice to normalize the radiated emission to that of an ideal blackbody. For an ideal blackbody, the infrared emission for the wavelength span Δλᵢ, i=1, . . . , Ncan be calculated using Planck's law;

$$I ( λ , T ) d λ = ( \frac{2 hc}{{λ}^{3}} ) \frac{1}{{e}^{\frac{hc}{λ kT}} - 1} d λ \qquad ( 4 )$$

where I(λ,T)dλ is the amount of energy per unit surface area per unit time per unit solid angle emitted at a wavelength range between λ and λ+dλ by a blackbody at temperature T. h is the Planck constant, c is the speed of light in a vacuum, k is the Boltzmann constant, λ is the wavelength and T is the temperature in Kelvin.

### III. INPUT WAVEGUIDES AND WAVELENGTH FILTER

For the CMOS-FTIR spectrometer to be able to interpret the interferogram, the waveguides must only support a single mode for each discrete wavelength. Each mode in the waveguide travels at a different speed, i.e. each has a different effective refractive index, n_{eff}. If the waveguide supports more than one mode for a discrete wavelength, then when the light recombines in the interferometer, it would be impossible to differentiate between the modes and interpolate the spectrum. This is the main reason why for a broadband source N waveguides are needed, each only supporting the fundamental single mode for a wavelength span Δλᵢ, i=1, . . . , N. By changing the dimensions of the waveguide, i.e. height and width, the modes which will propagate in the waveguide can be controlled and higher order modes will scatter. For longer wavelengths, larger waveguides are needed; as an example for a wavelength of 1.4 μm the waveguides dimensions are 220 nm height and 600 nm width, while for a 7 μm wavelength the waveguide's height is 1.1 μm and width 3 μm.

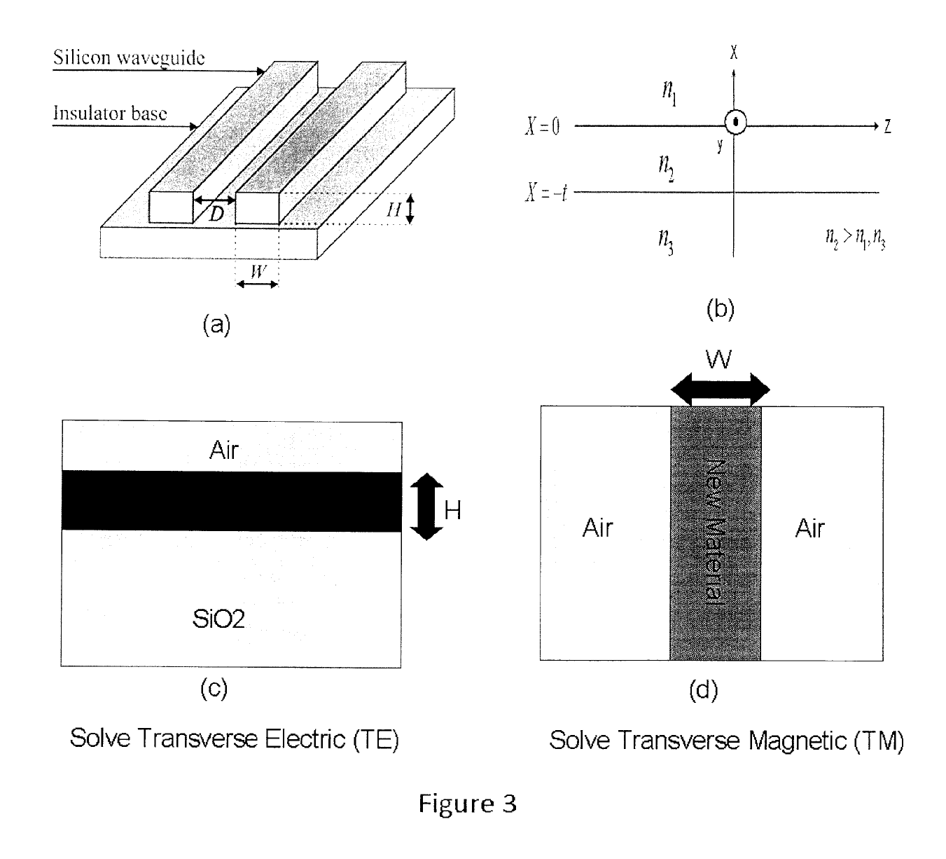

Waveguides work on the concept of total internal reflection and FIG. 3.a shows the structure of the rib waveguide, in which a rectangular silicon waveguide is on top of an insulator layer made of SiO2. Although the waveguides in the design will be covered by a material, in most cases SiO2, the solution shown here will assume that it is surrounded by air, thus leading to an asymmetric case. The solution for the asymmetric case is more general and a solution for the symmetric case, i.e. waveguides covered by SiO2, can be directly derived from the asymmetric case.

To solve the field distribution in the waveguides and extract the modes, first the transverse electric (TE) and transverse magnetic (TM) modes for a two dimensional waveguide will be analyzed and the effective refractive index method will be used. It is not possible to solve directly for the modes in a rib waveguide structure and therefore the effective refractive index method is used to derive the properties of the waveguide.

The effective refractive index method states that first a solution for the TE modes (or TM modes) is solved when taking a cross section view of the waveguides, and assuming it is infinitely wide as shown in FIG. 3.c. After solving for the two dimensional structure, an effective refractive index of the structure in FIG. 3.c is calculated. The next step is to use the effective refractive index found from FIG. 3.c and use it instead of the refractive index of silicon when looking from the top view as shown in FIG. 3.d. With the new material, having a refractive index calculated from the first step, the TM mode (or TE mode if initially TM mode was used) is solved for the structure shown in FIG. 3.d and the final effective refractive index of the three dimensional waveguide is derived.

The infrared radiation will propagate in the waveguide at a velocity corresponding to the effective refractive index.

To solve the TE and TM modes of the two dimensional structure of FIG. 3.b is used. The solution for the TE modes, i.e. the electric fields is in the y direction is shown in (5).

$${E}_{y} ( x ) = \{ \begin{matrix}{Ce}^{- qx} & ; x \geq 0 \\ C [ cos ( hx ) - \frac{q}{h} sin ( hx ) ] & ; 0 \geq x \geq - t \\ C [ cos ( ht ) + \frac{q}{h} sin ( ht ) ] {e}^{p ( x + t )} & ; x \leq - t\end{matrix} \\ q = \sqrt{{β}^{2} - {k}_{0}^{2} {n}_{1}^{2}} , p = \sqrt{{β}^{2} - {k}_{0}^{2} {n}_{3}^{2}} , h = \sqrt{{k}_{0}^{2} {n}_{2}^{2} - {β}^{2}} \\ {k}_{0} = 2 π \text{/} {λ}_{0} , β = {k}_{0} {n}_{eff} \qquad ( 5 )$$

where C is a constant. Using (5) the mode condition for the TE mode is shown in (6).

$$tan ( ht ) = \frac{p + q}{h ( 1 - \frac{pq}{{h}^{2}} )} \qquad ( 6 )$$

The mode condition is the eigenvalue equation for the TE modes of the asymmetric slab waveguide, i.e. n₁≠n₃. Equation (6) is an implicit relationship which involves the wavelength, refractive index of the layers and core height as known quantities and the propagation constant β as the only unknown quantity. There are only discrete values of β that satisfy (6), the discrete solutions of β are the discrete modes that a waveguide supports. Each solution of β is then used in (5) to solve the field profile and effective refractive index of the waveguide. The effective refractive index is used in FIG. 3.d as the refractive index of the new material instead of silicon and the TM mode is solved using (7) and FIG. 3.b (FIG. 3.d is rotated 90 degrees to align with the coordinate system in FIG. 3.b).

$${H}_{y} ( x ) = \{ \begin{matrix}- \frac{h}{q} {Ce}^{- qx} & ; x \geq 0 \\ C [ - \frac{h}{q} cos ( hx ) + sin ( hx ) ] & ; 0 \geq x \geq - t \\ - C [ \frac{h}{q} cos ( ht ) + sin ( ht ) ] {e}^{P ( x + t )} & ; x \leq - t\end{matrix} \\ q = \sqrt{{β}^{2} - {k}_{0}^{2} {n}_{1}^{2}} , p = \sqrt{{β}^{2} - {k}_{0}^{2} {n}_{3}^{2}} , h = \sqrt{{k}_{0}^{2} {n}_{2}^{2} - {β}^{2}} \\ \overline{q} = \frac{{n}_{2}^{2}}{{n}_{1}^{2}} q , \overline{p} = \frac{{n}_{2}^{2}}{{n}_{3}^{2}} p \\ {k}_{0} = 2 π \text{/} {λ}_{0} , β = {k}_{0} {n}_{eff} \qquad ( 7 )$$

where C is a constant. Using (7) the mode condition for the TM mode is shown in (8)

$$tan ( ht ) = \frac{\overline{p} + \overline{q}}{h ( 1 - \frac{\overline{pq}}{{h}^{2}} )} \qquad ( 8 )$$

Again the discrete solutions of β in (8) are the TM modes of the waveguide in FIG. 3.d. The β solutions are used in (7) to extract the magnetic field profile and effective refractive index of the three dimensional waveguide. The effective refractive index is a measure of the velocity in which the infrared light will propagate in the waveguide. Using the solutions to (5) and (7), the power flowing in the direction of propagation can be derived using the complex Poynting vector shown in (9).

$${\vec{S}}_{ave} = \frac{1}{2} Re ( \vec{E} \times {\vec{H}}^{*} ) \qquad ( 9 )$$

where \vec{E}×\vec{H}* is the complex Poynting vector and \vec{S}ₐᵥₑ is the power flowing across an area, i.e. W/m².

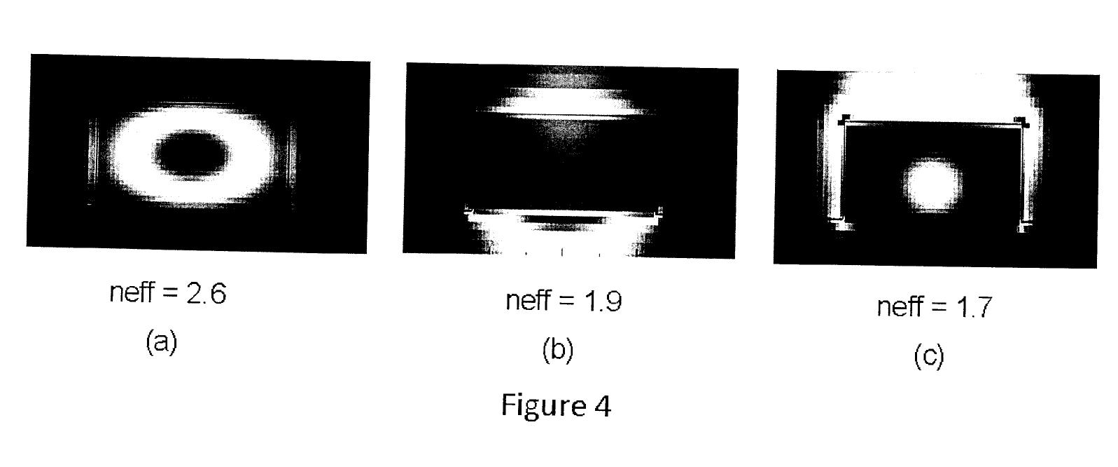

The power flowing in a waveguide of 220 nm in height and 600 nm width is shown in FIG. 4. The mode profile is shown using a Finite Differential Time Domain (FDTD) simulation.

The power distribution for the first three lowest order modes is shown for a wavelength of 1.4 μm. It can be seen that only the lowest order mode (a) will propagate in the wavelength and the two higher modes (b) and (c) will scatter into the substrate and the surroundings. The optical wave partially propagates in the silicon waveguide and partially in the air and SiO₂ substrate for slab waveguides. In 4(a) an effective refractive index of 2.6 is derived and this corresponds to most of the power being inside the silicon with a refractive index of 3.5 and only a small portion of the wave travels in the SiO₂ and air, with a refractive index of 1.5 and 1, respectively. For the other modes the wave is mostly travelling in the SiO₂ or air and therefore the effective refractive index is much lower.

For each wavelength span, Δλᵢ, i=1, . . . , N the waveguide geometries are derived using functions (5)-(9), above so that only the lowest order mode will propagate. It is important to note that each wavelength inside a certain span will propagate with a different effective refractive index, this property is the basis of deriving the interferogram which will be discussed in section IV.

One method that can be used to filter the desired wavelength span and couple the light into the waveguides from the infrared source is via diffraction. For each wavelength span a number of diffraction grating with varying periods can be used to couple the light into the waveguide supporting only the single mode propagation of the wavelength span Δλᵢ, i=1, . . . , N. The grating period Λ determines the wavelengths that will be coupled into the waveguide.

The Bragg condition in (10) describes how grating scattering modifies the light wave vector in the direction of propagation, z.

$${k}_{z} = β - m \frac{2 π}{Λ} \qquad ( 10 )$$

where β is the wave vector in the direction of propagation, m is an integer greater than 0 and Λ is the grating period. To find β a duty cycle of 50% is assumed and average of the effective refractive index of the waveguide (where H1 is the height of the waveguide partially etched to form the grating and H2 the height of the waveguide) is shown in (11)

$$β = \frac{π ( {n}_{eff\_H 1} + {n}_{eff\_H 2} )}{{λ}_{0}} \qquad ( 11 )$$

where λ₀ is the corresponding wavelength being diffracted. The free space wave vector shown in (12) is;

$${k}_{0} = \frac{2 π}{{λ}_{0}} \qquad ( 12 )$$

and therefore the diffracted angle θ can be derived in (13)

$$θ = {sin}^{- 1} \frac{{k}_{z}}{{k}_{0}} \qquad ( 13 )$$

Using the diffracted angle, the distance and height of the infrared source from the diffraction grating is optimized so the maximum light intensity diffracts into the propagation direction of the waveguide. It is important to note that broadband infrared emitters have much lower spectral irradiance than lasers or light emitting diodes which have a very narrow spectral bandwidth. For this reason the diffraction gratings should have a large area so that they can collect enough light for a workable SNR. The diffraction gratings are tapered down slowly so that all the optical power collected in the large grating will propagate in the much smaller waveguide. This approach allows for the broadband infrared light to propagate with similar optical intensities as used in narrow band telecommunication designs employing lasers or light emitting diodes.

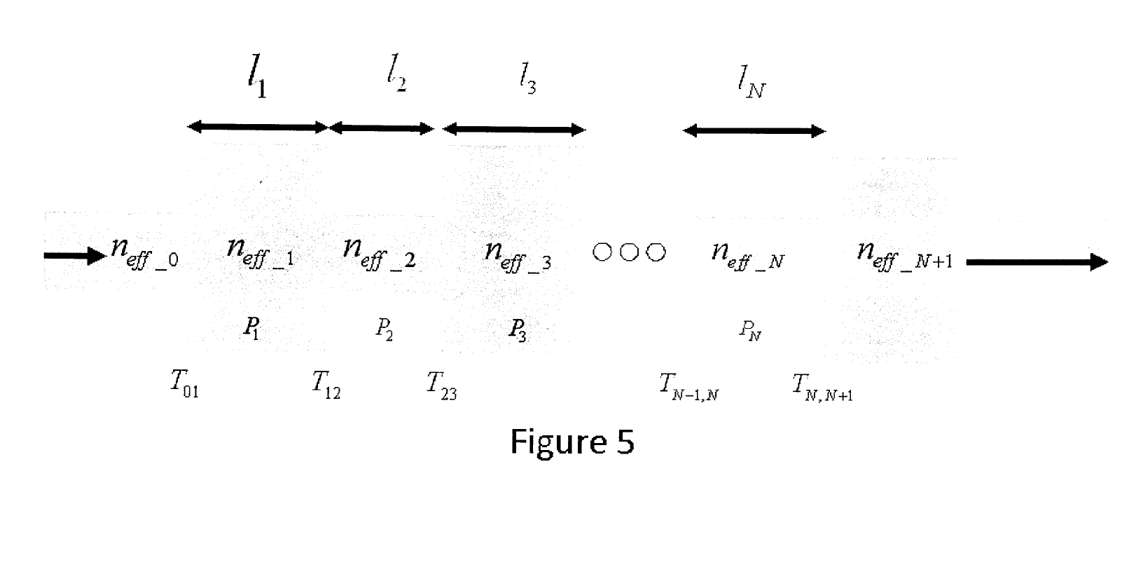

As each initial waveguide is designed to support only the wavelength span defined by its dimensions, there may be some overlap between different wavelength spans, i.e. there may be an overlap of wavelengths for Δλᵢ, i=1, . . . , N and Δλⱼ, j=1, . . . , N when i≠j in two separate waveguides. Most likely this will occur near the end of the wavelength span. To strictly define the wavelengths that propagate in the waveguide, so that there won't be an overlap of wavelengths being resolved twice in separate interferometers, a wavelength filter may be added. In addition, such a filter will reflect higher order modes that are loosely propagating in the waveguides, thereby reducing unwanted light (noise) in the design. A possible filter is the BGF which is similar to a multi-layer dielectric film which is used to reflect unwanted light based on different layers of varying refractive indices. The same idea can be used in the BGF, by only varying the widths of the waveguide, thereby creating sections of varying effective refractive index, n_{eff}. The idea is shown in FIG. 5, in which there are N+1 elements, each with a length of lᵢ; i=1, . . . , N and an effective refractive index n_{eff}_{_{—}}ᵢ; i=1, . . . , N. The transfer matrix method is used to solve the transmission and reflectance spectrum. The method is derived in (14).

$${P}_{i} = ( \begin{matrix}{e}^{{jk}_{0} {neff}_{i} {l}_{i}} & 0 \\ 0 & {e}^{- {jk}_{0} {neff}_{i} {l}_{i}}\end{matrix} ) ; i = 1 , … , N \\ {T}_{i , i + 1} = ( \begin{matrix}\frac{{neff}_{i} + {neff}_{i + 1}}{2 {neff}_{i}} & \frac{{neff}_{i} - {neff}_{i + 1}}{2 {neff}_{i}} \\ \frac{{neff}_{i} - {neff}_{i + 1}}{2 {neff}_{i}} & \frac{{neff}_{i} + {neff}_{i + 1}}{2 {neff}_{i}}\end{matrix} ) ; i = 0 , … , N \\ M = {T}_{01} {P}_{1} {T}_{12} {P}_{2} {T}_{23} {⋯P}_{N - 1} {T}_{N - 1 , N} {P}_{N} {T}_{N , N + 1} = ( \begin{matrix}{M}_{11} & {M}_{12} \\ {M}_{21} & {M}_{22}\end{matrix} ) \\ r = \frac{{M}_{21}}{{M}_{11}} \\ t = \frac{1}{{M}_{11}} \\ R = \vert r {\vert}^{2} \\ T = \frac{{n}_{eff , N + 1}}{{n}_{eff\_ 0}} \vert t {\vert}^{2} \\ R + T = 1 \qquad ( 14 )$$

where k₀ is the wave number, r and t are the reflection and transmission coefficients respectively. R and T are a measure of the reflectance and transmission respectively, i.e. R multiplied by 100 will give the total percent of reflected light with regards to the input. Using (14) a sharp band pass filter is easily designed so that only the wavelength span Δλᵢ, i=1, . . . , N will be transmitted; the rest of the wavelengths will be reflected back to the source. Alternatively any wavelength filter may be used in the optical path, such as a photonic hole lattice in which the diameter of the holes and spacing between holes will define the bandgap, i.e. which wavelengths will propagate through he lattice and which will be reflected or scattered.

This completes the design of the input waveguides. There are N waveguides each with a different geometry, with specific span of wavelengths propagating in them, and where each wavelength is only propagating in a single mode. Each of the N waveguides enters its own MZI to generate the interferogram; and the MZI is discussed in the next section.

### IV. MACH-ZEHNDER INTERFEROMETER (“MZI”)

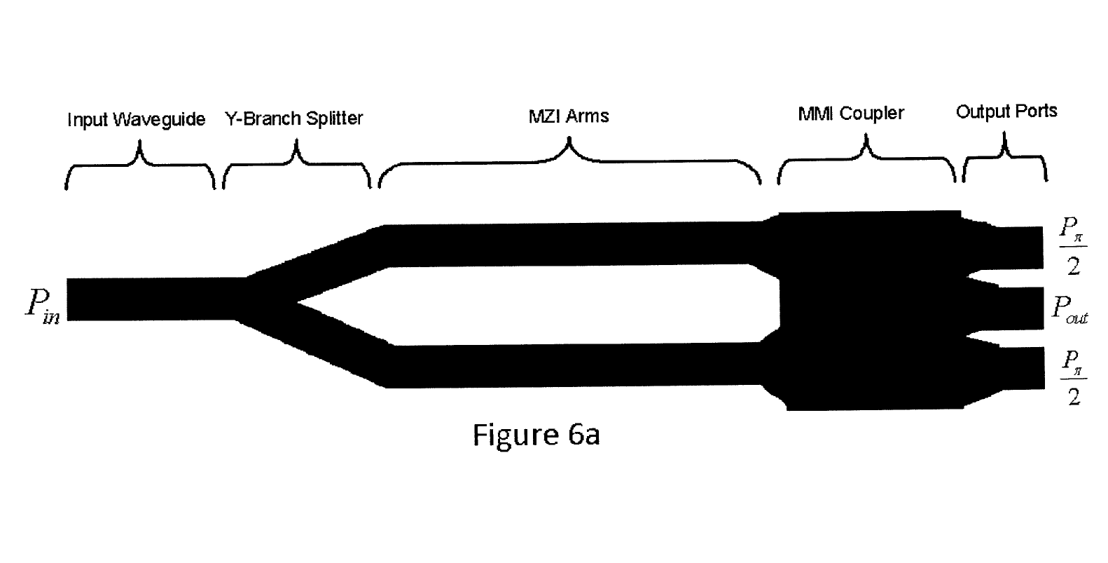

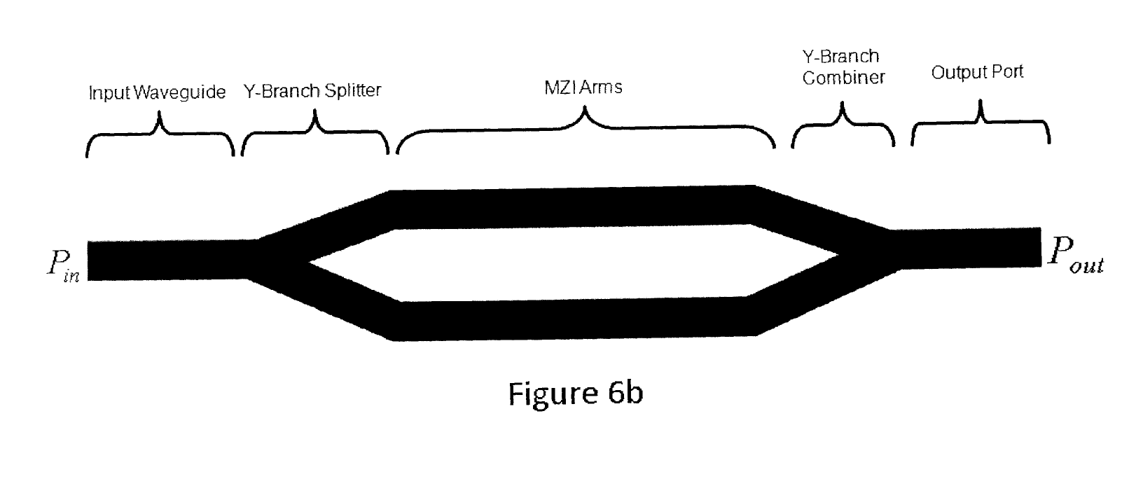

The MZI is the one of the most critical components in the FTIR spectrometer, and it is used in creating an interferogram. The detector will receive infrared radiation for the entire wavelength span every time it samples the infrared light intensity and will resolve the spectrum for each wavelength independently as a function of the destructive and constructive interference in the interferometer. The spectral resolution mainly depends on how much of an effective refractive index variation can be achieved between the two arms of the MZI. In the classical FTIR spectrometer, a moving mirror creates an optical path difference and each wavelength will have an interference pattern as a function of the mirror displacement. In the CMOS-FTIR spectrometer no movable parts, mirrors or otherwise are needed and the optical path difference effect is achieved by varying the effective refractive index of one arm in the interferometer in relation to the other arm. By varying the effective refractive index, the velocity of the light in the waveguide is changed and when light from the two arms of the MZI are re-combined a phase difference is introduced in direct relation to the effective refractive index variation between the two waveguides. A top view of the MZI interferometer is show in FIG. 6(a). for the case of an MMI coupler and FIG. 6(b). in the case of a Y-branch combiner.

The MZI consists of a single mode input waveguide supporting a wavelength span Δλᵢ, i=1, . . . , N derived from the previous section. The input light is split 50/50 into the two arms of the MZI by the Y-Branch splitter. The Y-branch splitter splits 50/50 for the entire wavelength span and does not have any wavelength dependence. The two split light waves travel the exact same distance in the MZI arms. In one of the MZI arms a refractive index variation is introduced in comparison to the other arm, thereby changing the relative velocity of the light in the arms, and introducing a phase difference between the two light waves traveling in the waveguides. The two split light waves will recombine in the MMI coupler (alternatively a Y-branch combiner can be used instead of the MMI coupler) and depending on the phase difference the waves will couple into the output ports. For a certain wavelength, when the two light waves are in phase, they will recombine and couple into the port Pₒᵤₜ. When they are out of phase by exactly π, half the light will exit the top port

$$\frac{{P}_{π}}{2}$$

and half will exit the bottom output port

$$\frac{{P}_{π}}{2} .$$

For a Y-branch combiner only the Pₒᵤₜ port exists and for the out of phase portion the light will scatter aout of the waveguide into the surrounding and substrate.

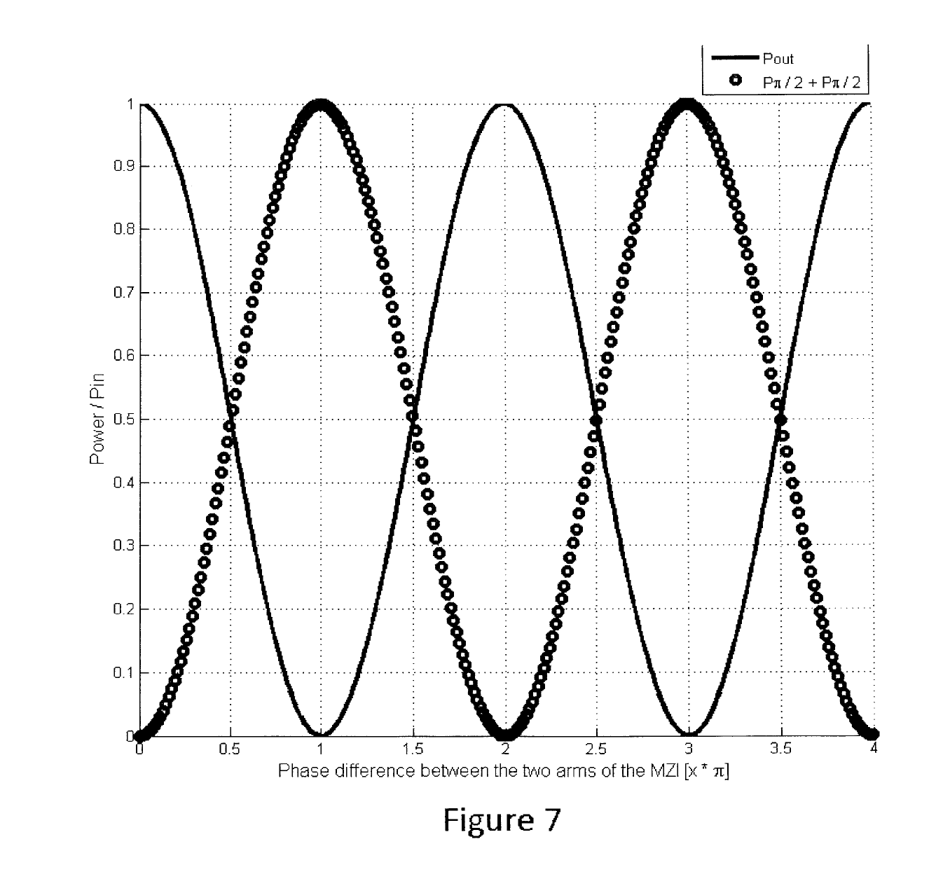

A graph of the output ports' light intensity normalized to the input light as a function of the phase difference between the two arms for a given wavelength is shown in FIG. 7. The graph represents the phase difference for one wavelength, the interferogram is generated when there is a broad range of wavelengths, and each will have a different phase difference for a certain effective refractive index difference. The solid line represents the middle output port and when the two arms of the MZI are in phase all the light is coupled into the middle port. The dotted line with circles represents the sum of the top and bottom port and when the light is out of phase by π the light is coupled half and half into each one of the ports.

Two possible modulation schemes are discussed; modulation based on the thermo-optic effect and modulation based on free carrier absorption (also known as the plasma dispersion) effect. Silicon possesses good thermal features, with its high thermo-optical coefficient (about three times higher than classical thermo-optical materials) and high thermal conductivity making modulation based on the thermo-optic effect very attractive. The only disadvantage is that modulation based on the thermo-optic effect is slower than modulation based on free carrier absorption. For spectroscopy applications this is usually not an issue: high speed modulation is typically more important for telecommunication applications. Free carrier absorption for spectroscopy applications may be used when higher speed modulation is desired. The disadvantages for modulation based on free carrier absorption is that it is more complicated to perform and to achieve modulation there will be loss in optical power causing one arm in the MZI to have less power than the other arm, i.e. the light won't be 50/50 in the ouput of the arms and will cause non-symmetrical results, which will require accommodation in processing and interpretation.

Due to the thermoelectric Seebeck effect, a voltage is applied over a bar of semi-conducting material leads to a temperature difference between both ends of the bar. A thermocouple is made of two dissimilar thermoelectric bars joined at one end. Thermoelectric coolers are composed of a large number of thermocouples which are electrically connected in series. Efficient thermoelectric coolers should be built with thermoelectric materials possessing a large Seebeck coefficient α, a low electric resistivity ρ, and a low thermal conductivity k. Table 2. shows the material properties of two sets of CMOS compatible thermoelectric materials, Poly-Si and poly-Si_{70%}Ge_{30%}. The n type material is doped with phosphorous and the p type material is doped with Boron. The thermoelectric material is heavily doped to reduce electrical resistivity and from table 2 it can be seen that the thermal conductivity of poly-Si_{70%}Ge_{30%} materials is lower.

TABLE 2
Material properties for 400 nm thick poly-Si and poly-SiGe layers

| | Doping | Seebeck | Electrical | Thermal |
|---|---|---|---|---|
| | Concentration | coefficient | resistivity | conductivity k |
| Material | c (cm⁻³ × 10²⁰) | α (uV/K) | ρ (mΩ · cm) | [W · m⁻¹ · K⁻¹] |
| n-Poly-Si | 2.5 | −57 | 0.813 | 31.5 |
| p-Poly-Si | 2.5 | 103 | 2.214 | 31.2 |
| n-Poly-SiGe | 2.5 | −77 | 2.37 | 9.4 |
| n-Poly-SiGe | 2.5 | 59 | 1.87 | 11.1 |

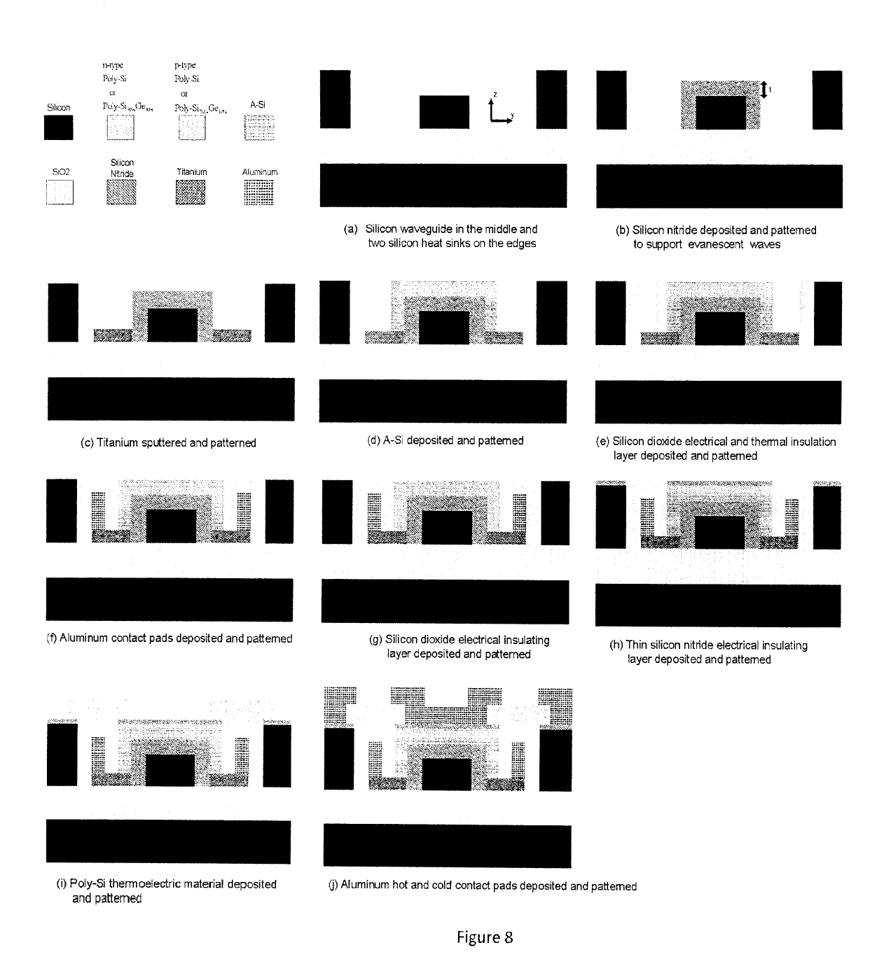

Spectral accuracy is an important figure of merit in FTIR spectrometers and should not be confused with spectral repeatability. Spectral accuracy is a measure of discrepancy between the actual measured value and the true value. Spectral repeatability often referred to as SNR, and the FTIR spectrometer's ability to reproduce the spectrum from the same sample, the same conditions, and the same configuration over a certain amount of time. Therefore noise is the measure of the spectral deviations between measurements, regardless of the output spectrum's proximity to the true value. Spectral accuracy is crucial, it is important for the FTIR spectrometer to produce wavelength information within the intended resolution. Therefore an approach is disclosed in FIG. 8 for modulation based on the thermo-optic effect while achieving high spectral accuracy. To achieve high spectral accuracy the actual temperature difference between the two arms, causing a change in refractive index between the two arms, needs to be precisely known when extracting the spectrum for a given voltage applied. For this reason a method using a layer of amorphous silicon (A-Si) as a temperature sensor with titanium contacts for higher thermal isolation is disclosed. In classical FTIR spectrometers usually a helium neon laser is added to measure the mirrors displacement and velocity to achieve high spectral accuracy. The disclosed method eliminates the need for the laser. In the disclosed method a temperature change caused by a voltage applied to the thermoelectric device will cause a change in resistance of the A-Si. When the resistance difference between the two arms is measured, the change in refractive index is known and desired spectral accuracy is achieved. The resistive information (voltage drop across the A-Si) per voltage applied to the thermoelectric device is used when extracting the spectrum in IIX. A-Si's properties and figures of merit are explained more in detail in section VI.

One example of a possible method to achieve both heating and cooling simultaneously, achieving a large temperature difference required for thermal modulation, is an integrated peltier structure. Alternatively any method such as resistive heating or heating via a metal layer may be used to achieve the thermal modulation. Usually architectures which are just based on heat generation in the waveguides will require the substrate of the chip to be cooled to a lower temperature.

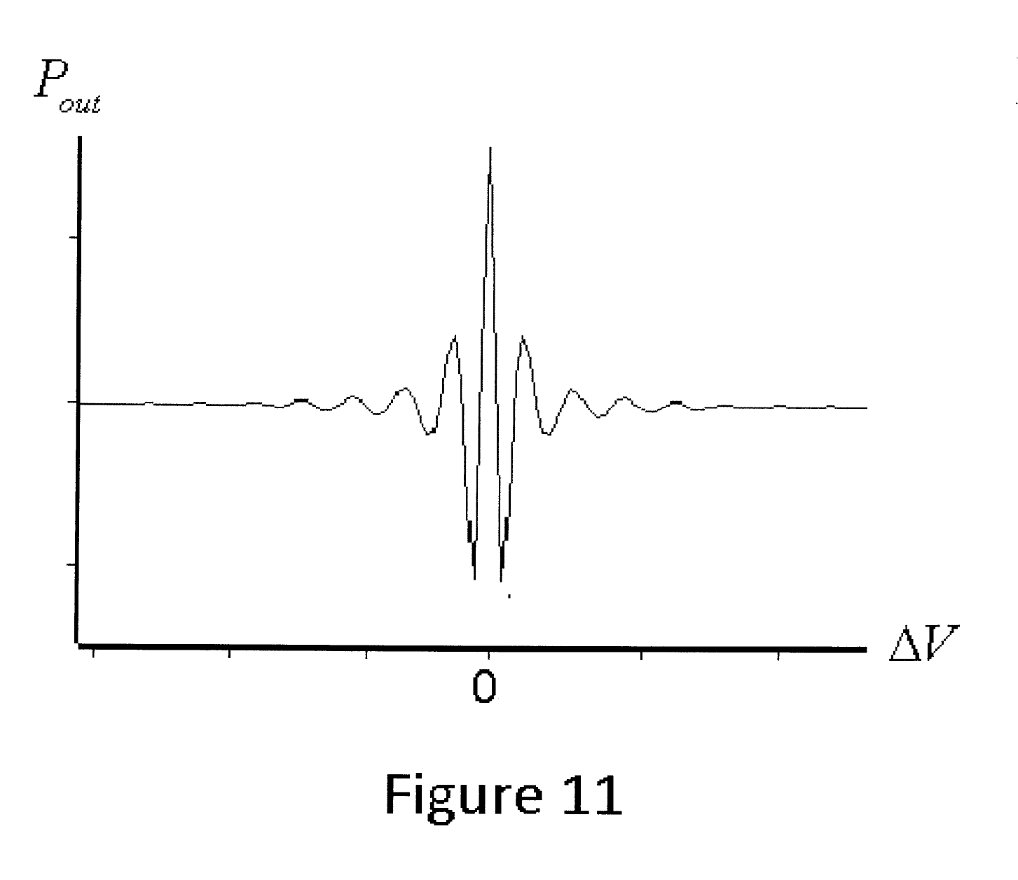

The fabricating layers involved in the disclosed integrated peltier device are shown in FIG. 8. The fabrication steps are only an illustration for conceptual understanding and do not depict the full fabrication flow or sequence. Initially in (a), silicon is etched leaving the waveguide in the middle and two silicon heat sinks on the edges. The heat sinks will be used to control the heat flow from the thermoelectric device, also known as Peltier device. Silicon nitride is deposited with LPCVD in (b). Silicon nitride, which is transparent to infrared radiation up to 11 μm, is used as cladding for the waveguide. The silicon nitride layer supports the evanescent wave of the optical field in the waveguide. The evanescent field plays an important role for the sample interface and will be discussed more in detail in section V. In addition silicon nitride has a much higher thermal conductivity than silicon dioxide; therefore the heat taken or applied by the Peltier device will propagate more efficiently to the silicon waveguide. The thickness “t” of the silicon nitride should be as thin as possible to achieve good thermal conduction to the silicon, but has to be thick enough to support the evanescent wave. The thickness “t” also applies to the width of the silicon nitride needed on the sides of the waveguide. The minimum thickness is derived by the penetrating depth of the evanescent wave in the waveguide. From Beer Lambert's law, the electric field in the silicon nitride is (15)

$$\frac{E}{{E}_{0}} = exp ( - α z ) \qquad ( 15 )$$

where E is the electric field as a function of the distance z which is normal to the boundary of the silicon and silicon nitride and E₀ is the initial electric field intensity at the boundary. α is the electric field amplitude decay coefficient and is derived in (16) for the optical waveguide in FIG. 11.

$$α = \frac{2 π}{λ} {( \frac{{sin}^{2} θ}{Δ {n}^{2}} - 1 )}^{1 \text{/} 2} \\ {d}_{p} = 1 \text{/} α \qquad ( 16 )$$

The penetration depth dₚ is defined as when the field drops to 1/e (37%) of the initial field. θ is the angle of incidence, λ is the wavelength and Δn is the relative refractive index of the two materials. For the angle of incidence, as shown in equations (5)-(9) only discrete modes exist, in the case of the present invention the waveguide is designed for a single mode. The angle of incidence is derived in (17) by taking the angle between the propagation constant β and the wave number kₙ_{_{—}}_{silicon} of the reflected light in the silicon waveguide.

$$θ = arccos ( \frac{β}{{k}_{n\_silicon}} ) = arccos ( \frac{{n}_{eff}}{{n}_{silicon}} ) \qquad ( 17 )$$

In (c) a thin layer of titanium is sputtered for contact connections to the A-Si. As shown in Table 1, titanium's thermal conductivity is about ten times smaller than aluminum. Aluminum's enormous thermal conductivity leads to a sensitivity drop of the A-Si temperature sensor and therefore titanium contacts improve the temperature sensor's performance. In (d) A-Si is deposited and doped with Boron to obtain a high Temperature Coefficient of Resistance (TCR). A-Si film is patterned for a good connection to the titanium with reactive ion etching (RIE) in reactive SF₆ gas. In (e) a thick layer of silicon dioxide is deposited with PECVD. The silicon dioxide acts both as an electrical insulation layer for the A-Si but also as a good thermal insulation layer for the silicon heat sinks. In (f) aluminum is deposited and patterned on the titanium for electrical conductance and is used as the contact layer for the temperature sensors pads. The A-Si temperature sensor covers all the length of the MZI arm to best and most accurately sense the temperature of the waveguide. In (g) silicon dioxide is deposited with PECVD, acting as an electrical insulating layer for the pads of the temperature sensor. The aluminum pads are routed along the arm of the MZI and contact to the pads is made at the end of the MZI arm. In (h) a thin layer of silicon nitride is deposited with LPCVD acting as an electrical insulating layer. The silicon nitride layer is kept thin for good thermal conductance from the Peltier device to the silicon heat sinks and silicon waveguide. In (i) poly-Si or poly-SiGe thermoelectric material is deposited with LPCVD and patterned. The n-type material was diffused with phosphorous in a high temperature furnace while the p-type material is capped by mask oxide. The p-type material is doped with Boron while the n-type material is capped. The poly-Si or poly-SiGe is patterned with reactive ion etching (RIE) in reactive SF₆ gas. Finally in (j) aluminum is deposited and patterned, forming the Peltier device.

In the cooling mode, current flows from the n-type material past the bridge metal (aluminum) to the p-type material. The bridge metal becomes colder than the aluminum contacts to the silicon heat sinks. If the polarity of the voltage applied to the Peltier device is reversed, the bridge becomes hotter than the contact pads to the heat sink. In both cases, the lack of heat or heat propagates to and through the A-Si temperature detector to the silicon waveguide, thereby changing the refractive index of the waveguide by changing its material's temperature. The Peltier devices are connected in series throughout the length of the MZI arm. The aluminum bridge is formed in a U-shape to allow sufficient cooling power and temperature difference facilitated by the small thermal bypass of air.

Silicon is a good material to use for thermo-optical modulation because of its high thermo-optic coefficient. The refractive index “n” of a material arises from the molecular polarizability α according to the Lorentz-Lorenz formula in (18)

$$\frac{{n}^{2} - 1}{{n}^{2} + 2} = \frac{ρ ( T ) α ( ρ , T )}{3 {ɛ}_{0}} \qquad ( 18 )$$

where ρ is the molecular density, T is the temperature, and ∈₀ is the permittivity of free space. Differentiating equation (18) with respect to the temperature gives the refractive index dependence on temperature, i.e. the thermo-optic coefficient. For silicon the thermo optic coefficient is approximately

$$\frac{d n}{d T} \approx 2.4 \times {10}^{- 4} [ {K}^{- 1} ] \qquad ( 19 )$$

Equation (19) is just the refractive index variation of silicon as a function of temperature, the optical wave in the waveguide travels with a velocity of n_{eff} and therefore when calculating the phase difference between the two arms, equations (5)-(9) need to be recalculated with the new refractive index of silicon under each temperature condition to extract n_{eff}. It is also important to note that silicon has a low thermal expansion and therefore from (18) it has a positive thermo-optic coefficient. For materials with high thermal expansion the thermo-optic coefficient is negative. By applying a different voltage to each of the thermo-optic modulators in the two arms of the MZI, each wave will travel with a different velocity due to the change in refractive index from (19) and changing n_{eff}. The voltages are applied in such a manner, i.e. one is increasing and other decreasing to achieve a 2π phase difference between all the wavelengths in the span Δλᵢ, i=1, . . . , N. The spectral resolution therefore depends upon how close two wavelengths can undergo a 2π phase difference in the interferometer. For a given wavelength λ₀ it is known that the wavenumber β expresses the number of radians of phase change that the wave undergoes per a given length (20)

$$β = \frac{2 π {n}_{eff}}{{λ}_{0}} \qquad ( 20 )$$

where λ₀ is the wavelength in free space. Using (20) the spectral resolution can be derived by taking the maximum n_{eff} difference achievable between the two arms and finding the closest two wavelengths that undergoes a total of 2π phase difference. It can also be derived from (20) that increasing the length of the arms in the MZI increases the spectral resolution. The thermo-optic effect is a very attractive method for modulation in the MZI because of its simplicity, and no loss is introduced in the waveguide (but it is slower than using the other method which is free carrier absorption).

The second approach that can be used to achieve modulation is based on free carrier absorption As an example for an architecture based on free carrier absorption a reverse biased diode may be used. Alternatively any architecture which achieves modulation by changing the number of free carriers in the optical path travelling the in the waveguides, may be used. The number of free carriers in the waveguides can be controlled by forming a reverse biased diode out of the silicon waveguide and applying a voltage, thereby changing the width of the depletion region. The width of the depletion region can be calculated using (21).

$$W = {[ \frac{2 {ɛ}_{0}}{q} ( \frac{{N}_{A} + {N}_{D}}{{N}_{A} {N}_{D}} ) ( {V}_{bi} - V ) ]}^{\frac{1}{2}} \qquad ( 21 )$$

where ∈₀ is the permittivity, q is the elementary charge, N_{A} is the concentration of the acceptors, N_{D} is the concentration of the donors, V_{bi} is the built-in potential and V is the voltage applied. For modulation based on free carrier absorption, the number of free carriers generated per voltage can be derived and refractive index difference between the two arms can be extracted using Kramers-Kroing relations.

The relation between the free carrier absorption and the refractive index can be described using Kramers-Kroing. The refractive index can be written as n+ik where the real part n is the conventional index of refraction and the imaginary part k is the optical extinction coefficient. k is related to α, the linear absorption coefficient, by the relation k=αλ/4π where λ is the optical wavelength. The Kramers-Kroing coupling between Δn and Δα can be expressed as follows;

$$Δ n ( w ) = ( c \text{/} π ) P {\int }_{0}^{∞} \frac{Δα ( {w}^{′} )}{{w}^{′2} - {w}^{2}} d {w}^{′} \qquad ( 22 )$$

where hw is the photon energy and P the cauchy principle value. Absorption may be modified by an altered free-carrier concentration (ΔN):

Δα(w,ΔN)=α(w,ΔN)−α(w,0) (23)

Due to the fact that the photon energy is expressed in electron-volts and the units of α are typically cm⁻¹, it is convenient to re-write equation (22) using the normalized photon energy “V”, where V=hw/e:

$$Δ n ( V ) = ( hc \text{/} 2 {π}^{2} e ) P {\int }_{0}^{∞} \frac{Δα ( {V}^{′} )}{{V}^{′2} - {V}^{2}} d {V}^{′} = ( 6.3 \times {10}^{- 6} [ cm \cdot V ] ) P {\int }_{0}^{∞} \frac{Δα ( {V}^{′} )}{{V}^{′2} - {V}^{2}} d {V}^{′} \qquad ( 24 )$$

A good approximation of the free carrier absorption effect can be described by a first order approximation descending from the classical Drude model

$$Δα = \frac{{e}^{3} {λ}^{2}}{4 {π}^{2} {c}^{3} {ɛ}_{0} n} ( \frac{Δ {N}_{e}}{{m}_{e}^{2} {μ}_{e}} + \frac{Δ {N}_{h}}{{m}_{h}^{2} {μ}_{h}} ) \qquad ( 25 )$$

where Δn and Δα are the real refractive index and the absorption coefficient variations respectively, e is the electron charge, ∈₀ is the permittivity of free space, n is the refractive index of intrinsic Silicon, m is the effective mass, μ is the free carrier mobility, ΔN is the free carriers concentration variation and the subscripts e and h refer to electrons and holes respectively. Using Krmaers-Kroing relations, the change in refractive index from (25) is extracted, giving:

$$Δ n = - \frac{{e}^{2} {λ}^{2}}{8 {π}^{2} {c}^{2} {ɛ}_{0} n} ( \frac{Δ {N}_{e}}{{m}_{e}} + \frac{Δ {N}_{h}}{{m}_{h}} ) \qquad ( 26 )$$

Using (26), the free carrier absorption effect gives approximate refractive index variations on the scale of −1×10⁻³, note that it is negative, i.e. conflicting in polarity to the thermo-optic effect. The disadvantages for the technique are complexity in comparison to using the thermo-optic effect, but more importantly a change in refractive index causes an optical loss. This can be problematic in a spectroscopy application if a precise spectrum is to be evaluated because this will cause one arm of the MZI to have more power than the other arm in the MZI causing an anti-symmetric recombination of light. It is also difficult to compensate for the loss because the loss is dependent on the state of the diode and varies throughout the modulation. With that said, taking a differential measurement, i.e. first creating the interferogram for a known sample and then for the unknown sample, the anti-symmetric losses can be subtracted out. The main advantage for using free carrier absorption for modulation is speed; it is much faster than using a thermo-optic effect for modulation: a few hundred times faster in most cases.

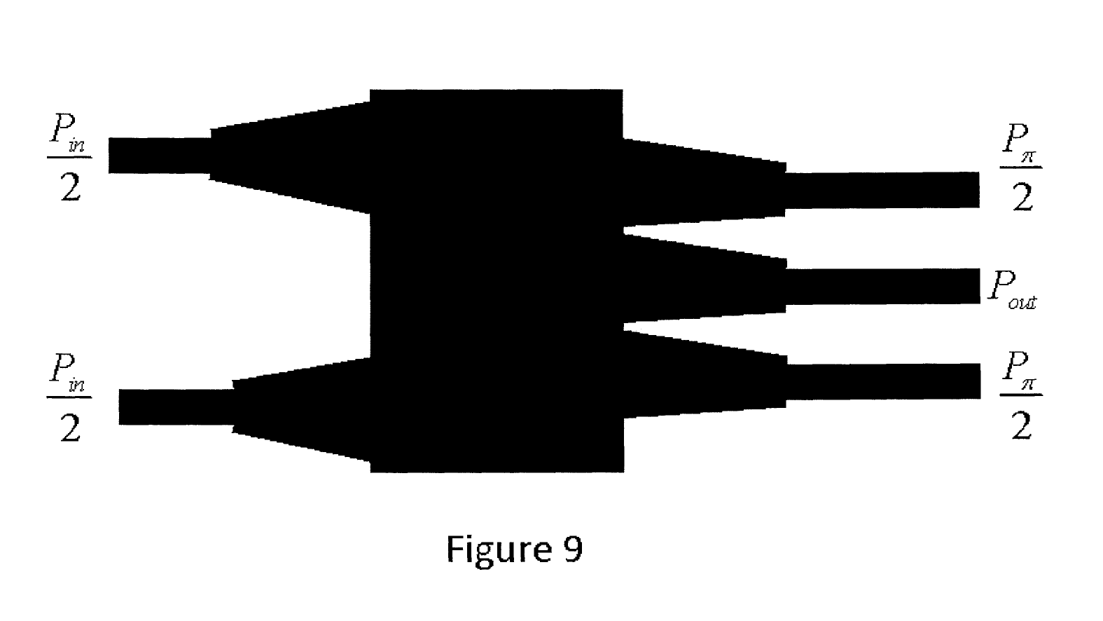

For constructive and destructive interference between the light in the two arms of the MZI to occur as an example of a possible recombination method an MMI coupler is shown in FIG. 9 (alternatively a y-branch combiner can be used). The MMI has two input ports coming from the MZI and it is assumed that each input has half of the total light intensity. There are three output ports, the P₀ output port will have the light coupled into it when the two inputs are in phase and the output ports P_{π}/2 will have the light coupled into them half and half when the two input ports are π out of phase. The output ports are tapered and their distances apart from one another are optimized to collect the most amount of light depending upon the phase conditions of the inputs.

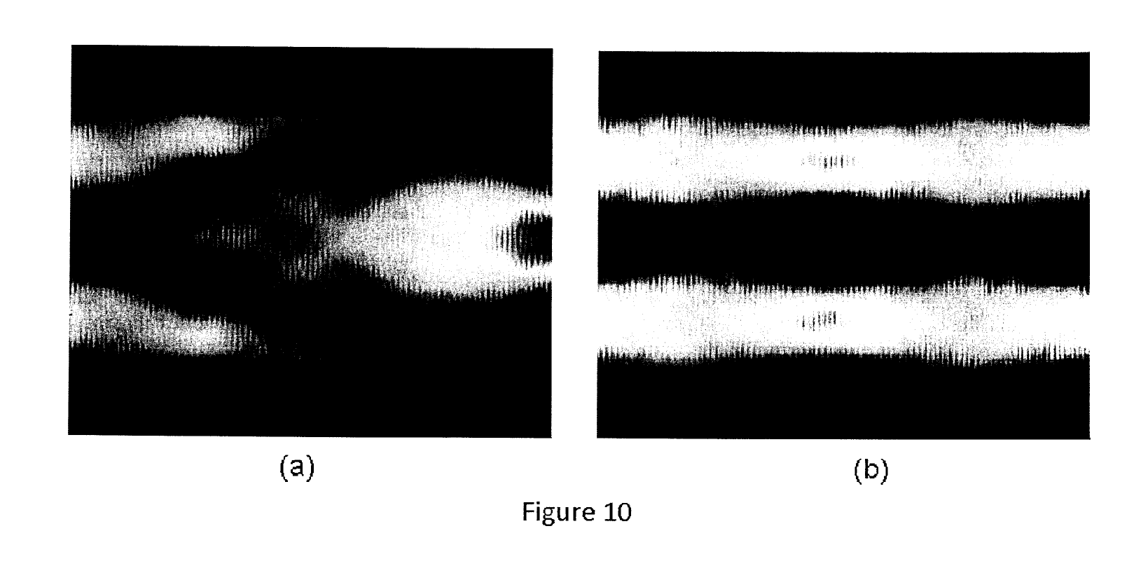

The MMI coupler works on the principle of self-imaging effect. An input field profile is reproduced in single or multiple images at periodic intervals along the propagation direction. This occurs due to constructive interference between the waveguide modes. The beat length L_{π} is derived by using the propagation constants between any two lowest-order modes.

$${L}_{π} = \frac{π}{{β}_{0} - {β}_{1}} ≅ \frac{4 {n}_{r} {W}_{e}^{2}}{3 {λ}_{0}} \qquad ( 27 )$$

where β₀ and β₁ are the propagation constants of the two lowest order modes, nᵣ is the refractive index of the rib waveguide, Wₑ is the effective width of the multimode section of the splitter/combiner, and λ₀ is the free space wavelength. The FDTD simulation results of the recombination of the two arms of the MZI in the MMI are presented in FIG. 10. When the two inputs are in phase the input light is coupled into the middle port and when the two inputs are π out of phase the input light is coupled half and half into the top and bottom output ports.

With the MMI recombining the signals for all the wavelengths in the span Δλᵢ, i=1, . . . , N, the spectral information is encoded in the interferogram all at once as a function of the refractive index variations in the MZI. By measuring the optical power from the middle port for every refractive index variation until the desired spectral resolution is achieved, all the absorptive spectral distribution of the sample under test for the wavelength span Δλᵢ, i=1, . . . , N is derived. The top and bottom output ports of the MMI are used to guide away the destructive interference part of the interferometer so it won't add optical noise to the system. In the next section possible sample interfaces are discussed and the decoding of the interferogram is discussed in section IIX.

### V. SAMPLE INTERFACES

From the MZI, specifically the Pₒᵤₜ port of the MMI coupler or Y-Branch combiner, comes the interferogram covering the wavelengths span Δλᵢ, i=1, . . . , N. As there are N wavelength spans there are N interferogram which are symbolized as I_{Δλ}_{ᵢ}(v); i=1, . . . , N. The interferogram is a function of the difference of voltage (ΔV) or current (ΔI) applied between the two arms in the MZI, for either the thermo-optic modulation or the free-carrier absorption modulation. An example of an interferogram is shown in FIG. 11. When there is no voltage difference between the arms, i.e. no effective refractive index variation, all wavelengths are in phase and the maximum center burst is at ΔV=0. As the effective refractive index variation between the arms is increased, i.e. ΔV≠0, the interferogram goes down as the constructive and destructive interference takes place in the MMI coupler or Y-branch combiner for different wavelengths.

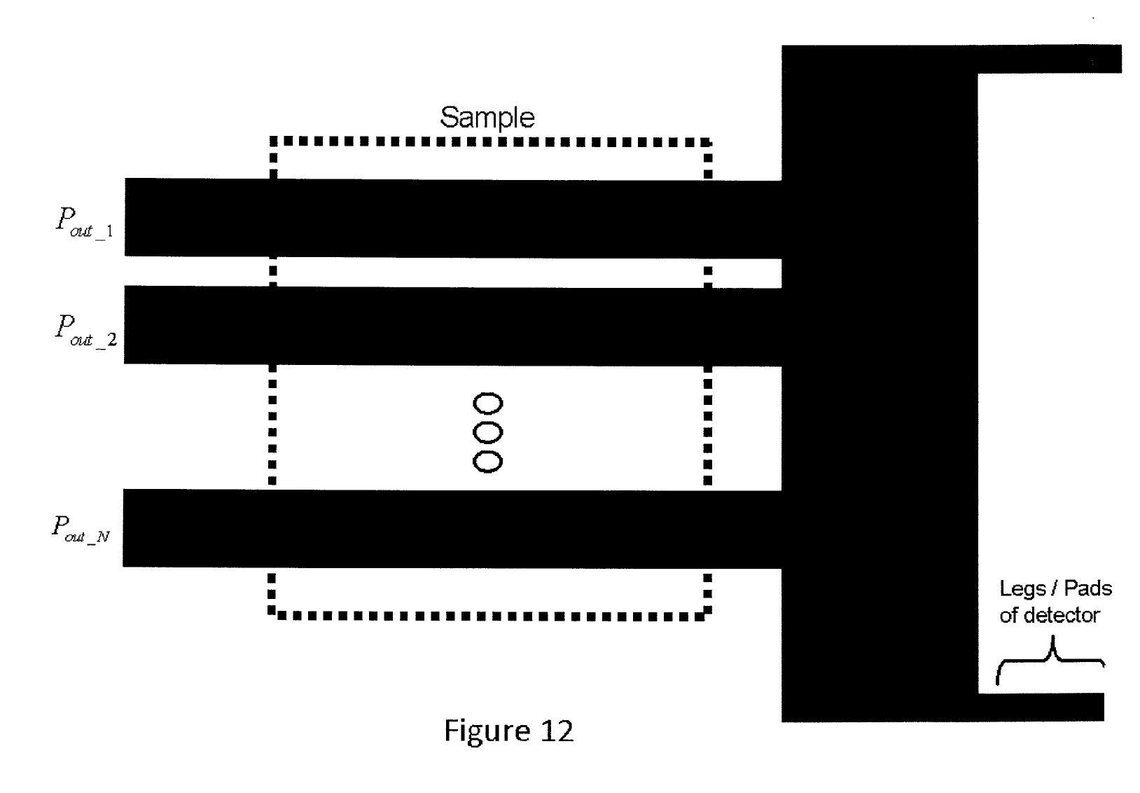

Each interferogram I_{Δλ}_{ᵢ}(v); i=1, . . . , N is applied to the sample and based on the absorption by the sample the spectrum is derived. This description discloses an ATR and an external reflectance method in which different angles of light can diffract out of the chip to the sample. The top view of the sample interface for the ATR method, for the case where only one infrared detector is used for all N interferograms, is shown in FIG. 12. The N interferograms I_{Δλ}_{ᵢ}(v); i=1, . . . , N coming from each MZI through ports Pₒᵤₜ_{_{—}}ᵢ; i=1, . . . , N at different times, due to the pulsing procedure of the infrared sources, travel below and in direct contact with the sample. The exponentially decaying evanescent wave traveling out of the boundaries of the waveguide penetrates into the sample and the corresponding wavelengths of the interferogram are absorbed by the sample. The infrared light that did not get absorbed continues to travel in the waveguide to the infrared detector or in the case of parallel operation to the infrared detectors, i.e. one detector for each of the N interferograms. The depth in which the evanescent wave penetrates the sample depends on both the refractive index of the sample and the wavelength. The penetration depth can be calculated using (5)-(9) in which the field is solved as a function of the distance traveled in the sample or using (15)-(17) in which the angle of reflectance in the waveguide is derived to solve the penetration depth. The advantage of using a single detector is that non-uniformity issues between detectors is not an issue but the disadvantage is that the infrared sources need to be pulsed for operation one at a time and this delays the derivation of the full spectrum. Furthermore a blackbody infrared source takes some time to turn off, i.e. cool down and special care needs be taken to make sure the source is fully off before the next one turns on. In the case of using N infrared detectors all the sources can work in parallel at the cost of having more hardware to support all the detectors. The infrared detector for the ATR method is a suspended structure and connections are made through the legs/pads.

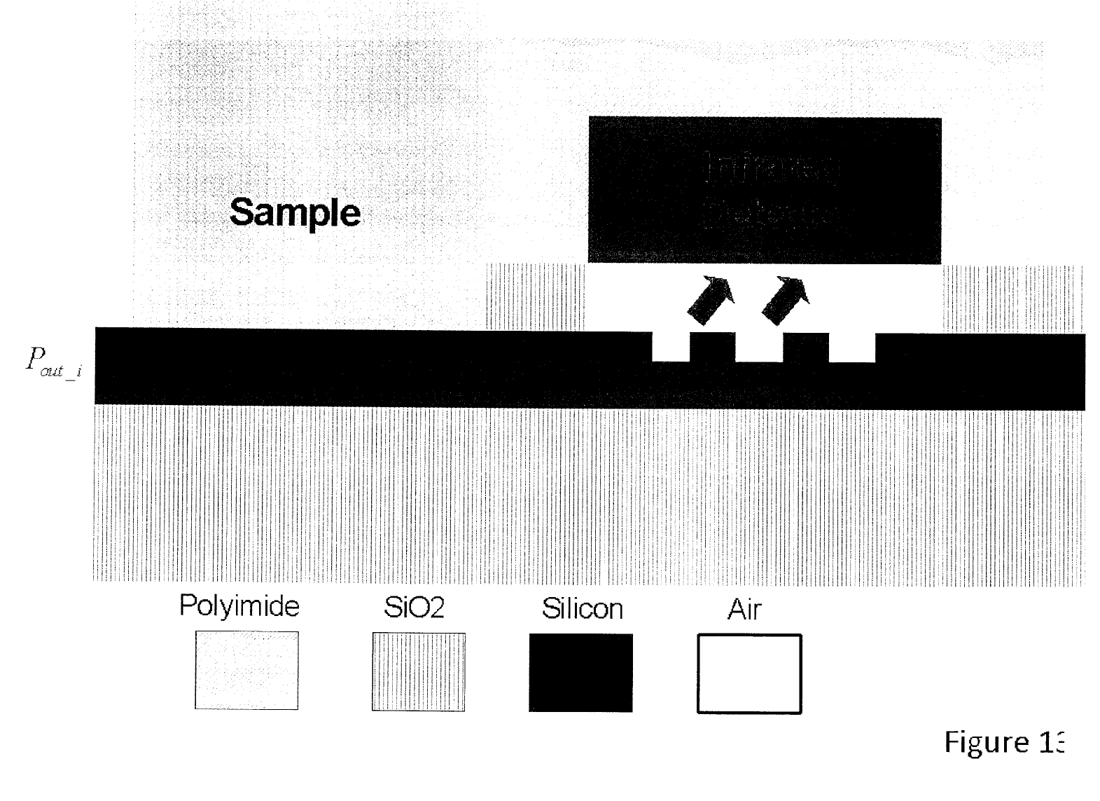

As an example a cross section view of the ATR sample interface for one of the waveguides using diffraction grating to output the light is shown in FIG. 13. The sample is placed in contact with the waveguide and the light that was not absorbed continues to travel in the waveguide and is later diffracted out into the thermally isolated suspended infrared detector. It is important for the detector to have good thermal insulation from the surrounding area and is therefore suspended above the waveguides and covered with polyimide. The infrared detector will be disclosed more in detail in the following section. Alternatively the detector can be placed at the end of the waveguide and the waveguide is tapered down so that almost of all the light that did not get absorbed by the sample will couple out of the waveguide into the absorbing layer of the infrared detector.

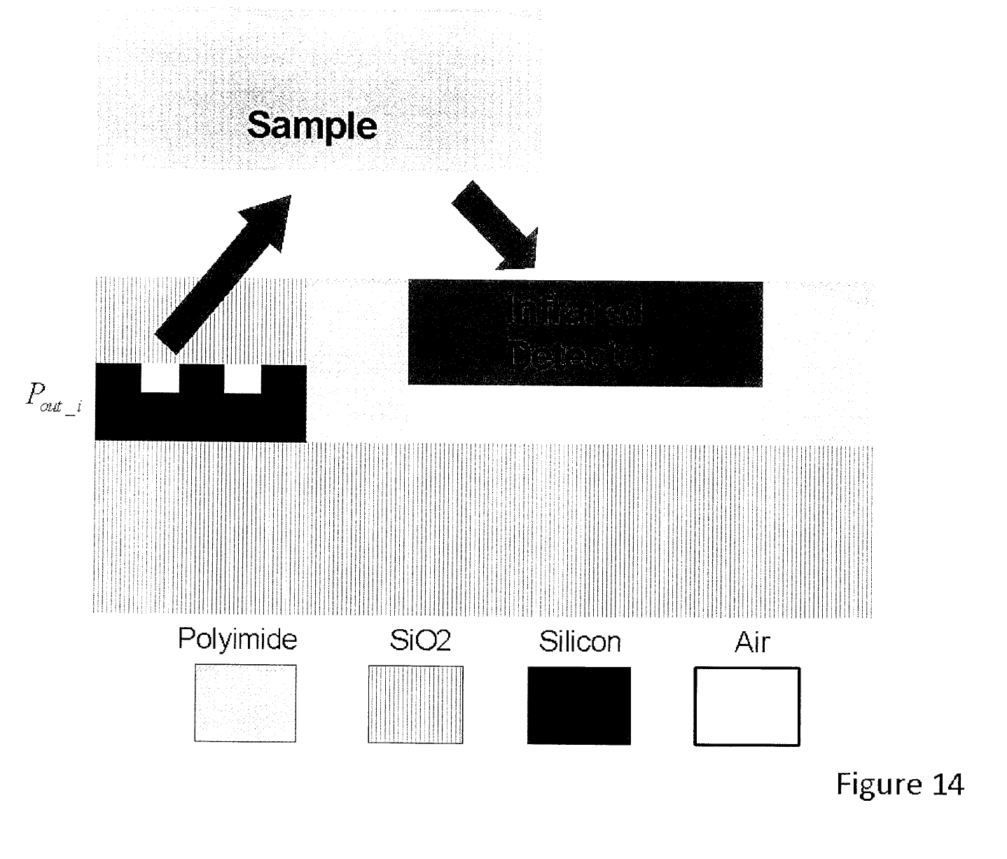

An alternate sample interface that can be incorporated involves the light leaving the waveguide at an angle corresponding to the diffraction equations derived in (10)-(13) and being reflected back from the sample onto the detector. The idea is shown in FIG. 14, in which a cross section for one waveguide is shown. The light exits the waveguide via diffraction and the angle can be controlled, for example 45° angles can be achieved as well as grazing angles down to a few degrees to measure samples in which the absorbance of the surface is important.

Because the waveguides are integrated into the chip together with the sample interface and the detector, a good degree of control and performance is achieved that is more difficult to achieve with other miniaturized FTIR spectrometers. In other miniaturized FTIR spectrometers such as those that use fiber-optics, it is difficult to align and couple light from the FTIR spectrometer to the sample and back with good accuracy and in a controlled manner. With the disclosed CMOS-FTIR spectrometer the whole process is done in the fabrication facilities in which accurate and precise equipment control the alignment and design.

### VI. INFRARED DETECTOR

Any infrared detector may be used. As an example, the detector proposed in the present disclosure is an uncooled microbolometer. The microbolometer architecture was chosen due the low cost, small size, broad brand spectral response and CMOS compatibility. Microbolometric detectors exhibit a change in resistance with respect to a change of temperature of the sensing material A-Si accompanying the absorption of infrared radiation. The uncooled microbolometer infrared detector incorporates A-Si as the temperature sensitive material. A-Si has low noise properties, high Temperature Coefficient of Resistance (TCR) and can be prepared with a range of electrical resistivities to meet the CMOS-FTIR spectrometer's resistance specifications.

To first understand the operation of the microbolometer a few important figures of merit are defined. Responsivity R_{V}, is the amount of output seen per watt of input radiant optical power and is defined in (28).

$${R}_{{ }_{V}} = \frac{{I}_{b} R βη}{{G ( 1 + {w}^{2} {τ}_{th}^{2} )}^{1 \text{/} 2}} \qquad ( 28 )$$

where I_{b} is the bias current, R is the infrared sensitive material resistance (A-Si), η is the ratio of absorbed to incident radiation, G is the total equivalent thermal conductance, w is the modulation frequency added to the infrared radiation, τₜₕ is the thermal response time defined by the ratio of the device thermal mass to its thermal conductance and β is the temperature coefficient of resistance (TCR) given by (29).

$$TCR = \frac{1}{R} \frac{d R}{d T} \qquad ( 29 )$$

where T is the temperature in Kelvin. The detectivity D* measures SNR normalized with respect to the detector active area (30).

$${D}^{*} = \frac{{R}_{V} \sqrt{A \cdot Δ f}}{{V}_{n}} \qquad ( 30 )$$

where Δf is the frequency bandwidth, A is the microbolometer area and Vₙ is the total noise voltage, including the background noise, the temperature fluctuation noise, Johnson noise and 1/f noise. An important figure of merit is noise equivalent power (NEP), which is the input power necessary to give a signal-to-noise ratio of unity (31).

$$NEP = \frac{{V}_{n}}{{R}_{V}} \qquad ( 31 )$$

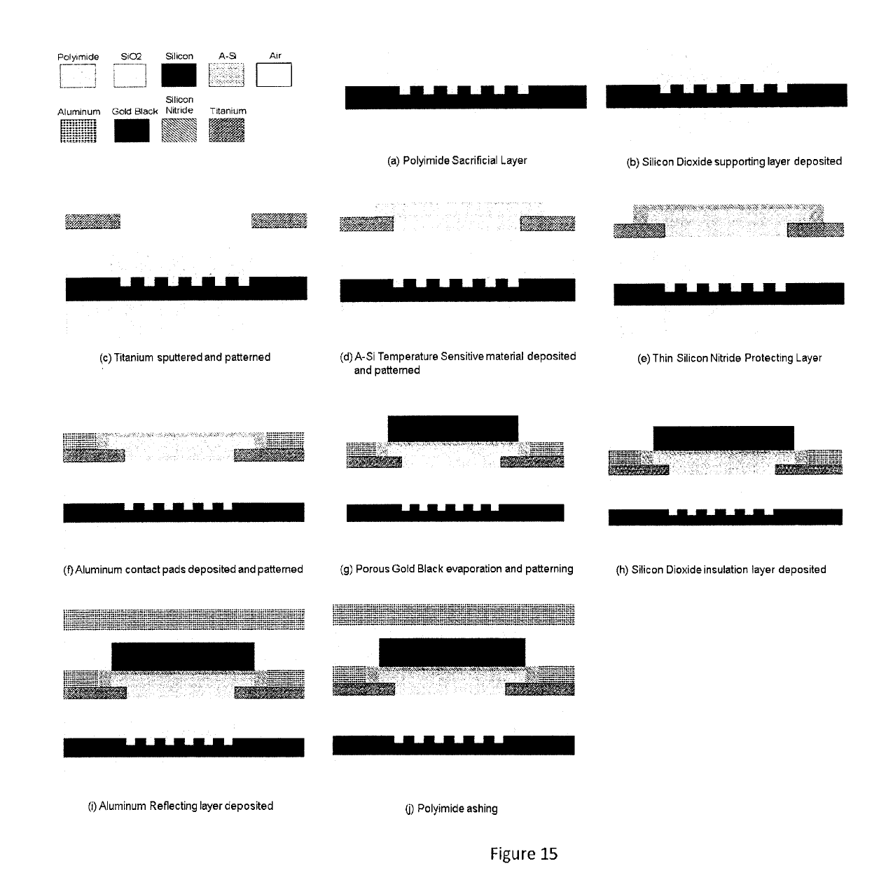

To ensure the performance required in an FTIR spectrometer, a microbolometer should have large values of β,R_{V},D* and low NEP. This description discloses a free-standing thermal detector with adequate thermal insulation, good figures of merit as defined in (28)-(31), and CMOS compatibility. The detector and its fabrication layers are shown in FIG. 15. The fabrication steps are only an illustration for conceptual understanding and do not depict the full fabrication flow or sequence. First a polyimide sacrificial layer is spun, cured and patterned by dry etching (a). In (b) a Silicon dioxide layer is deposited for the floating structure. In (c) a thin layer of titanium is sputtered for contact connections to the A-Si. As shown in Table 1, titanium's thermal conductivity is about ten times smaller than aluminum. Aluminum's enormous thermal conductivity leads to a sensitivity drop of the detector and therefore titanium contacts greatly improve the detector's performance. In (d) A-Si is deposited and doped with Boron to obtain the expected resistivity and TCR. The A-Si film is patterned for a good connection to the titanium with RIE in reactive SF₆ gas. In (e) a very thin layer of silicon nitride is deposited, the layer is used for electric insulation and is very thin to have good thermal conductance between the A-Si and the gold black absorbing layer. Aluminum is deposited and patterned on the titanium for electrical conductance and is used as the pads of the detector in (f). In (g) a porous gold black absorption layer is thermally evaporated. The gold black evaporation process is done under relatively low vacuum (·0.8 ton) to achieve the porous and black layer. The porous gold black layer absorbs nearly 100% of infrared light from 1.4 μm-15 μm. In (h) a thick silicon dioxide layer is deposited, which acts as good thermal and electrical insulation layer from the outside. In (i) an aluminum infrared reflecting layer is deposited, the reflecting layer is so that no infrared radiation from the outside will enter the microbolometer structure, as well any infrared radiation that did not get absorbed in the first pass will get reflected and absorbed by the porous black gold layer after reflection, thereby increasing the microbolometer performance. Lastly in (j) to form the floating structure, the polyimide sacrificial layer is removed by a microwave plasma ashing process.

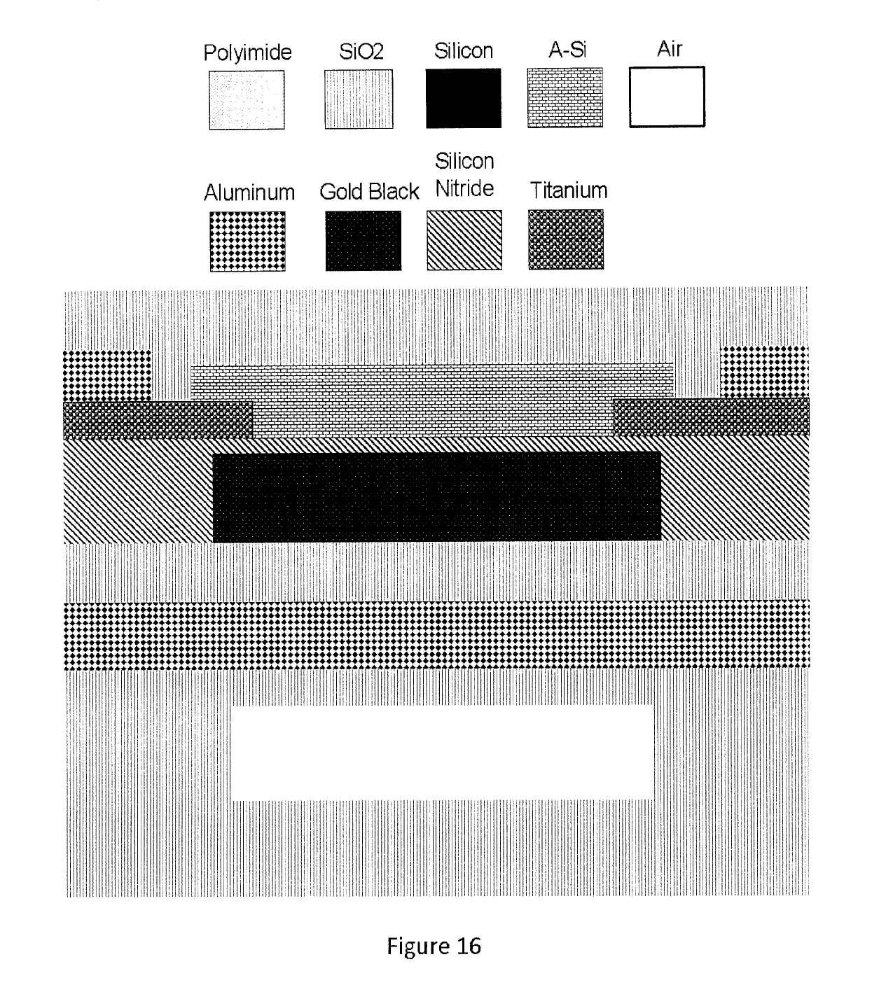

The disclosed microbolometer structure with thermal isolation and absorption method is well suited for an integrated CMOS-FTIR spectrometer. The fabrication steps in FIG. 15, discloses a thermally isolated micro-bolometer suitable for ATR sample interfaces. As shown in FIG. 13, the detector can be covered with polyimide acting as thermally insulating buffer from the sample and packaging. For external reflectance sample interfaces, the micro-bolometer structure is similar to FIG. 15, except now the infrared light comes from the direction of the sample so the structure is reversed. The thermal insulation and absorption concepts are the same and the detector is shown in FIG. 16. The free standing structure is formed the same as in FIG. 15, the aluminum reflecting layer is now placed on the bottom and the porous gold black absorption layer above it. The thin Silicon Nitride layer still acts as an electrical insulation layer and has good thermal conductance between the absorption layer and the A-Si. Any infrared light not getting absorbed by the gold black layer will be reflected back to the absorbing gold black layer from the aluminum layer on the bottom and this increases the detector efficiency.

### VII. ANALOG READOUT CIRCUIT AND THE DIFFERENTIAL DIFFERENCE AMPLIFIER

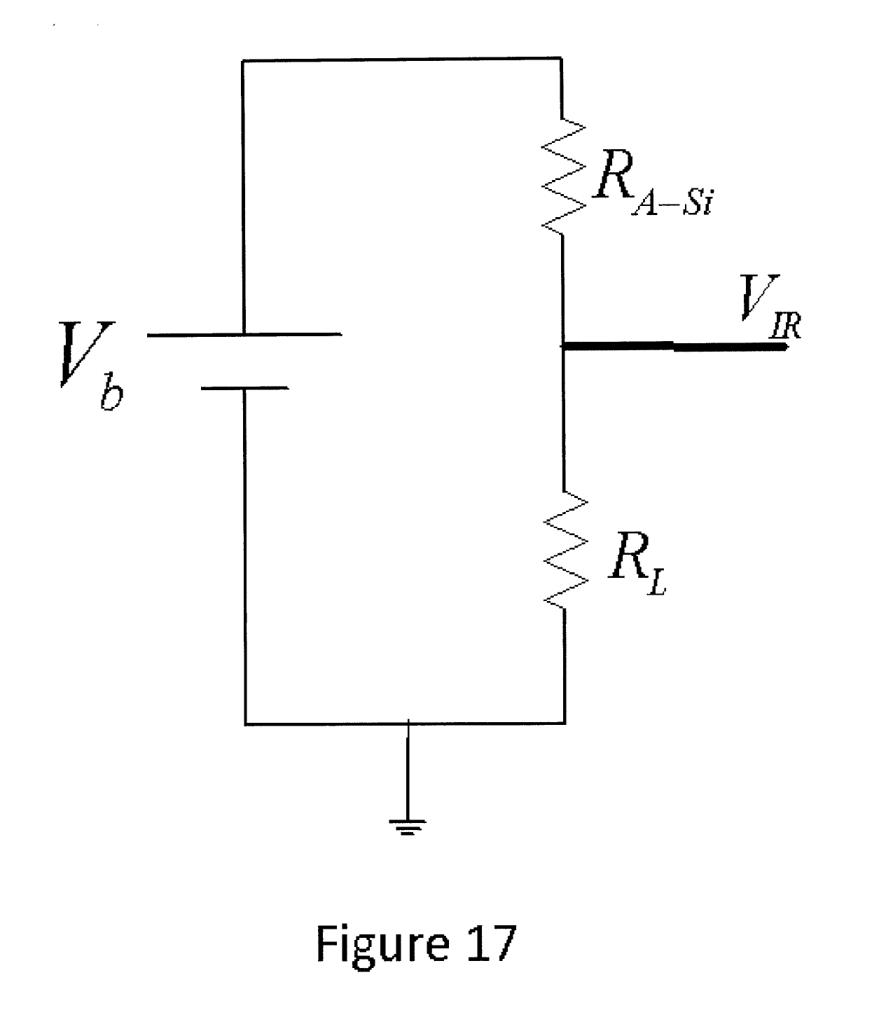

The A-Si in the configuration of FIG. 15 & FIG. 16 is a linear resistor and the resistance value changes linearly with temperature. It is desirable for the CMOS-FTIR spectrometer to be able to detect the slightest changes of temperature which means the slightest variations of resistance. The TCR of the detector is in the order of −3%/K and therefore to improve the detectivity of the chip a differential difference amplifier (DDA) can be used, in which variable gain can be added to the readout to increase the SNR. If only unity gain is desired a simple unity gain amplifier can be used instead of the DDA to readout the infrared detector's voltage values, i.e. reading out the voltage which can be translated to resistance or temperature values. A basic DC bias circuit is shown in FIG. 17, a DC source is connected in series with the A-Si detector (modeled as a resistor) and a load resistance. The voltage V_{IR} changes with resistance and indicates the amount of infrared radiation that was absorbed by the detector.

For the analog readout circuit to be able to distinguish slight changes of voltage, V_{IR}, a method for taking the difference between the previous readout to the current readout and amplifying this voltage difference is disclosed. This is done using the DDA which increases the SNR because the amplification is done on V_{IR} before additional readout noise sources are added (such as by the analog-to-digital conversion), thereby increasing the detectivity of the CMOS-FTIR spectrometer.

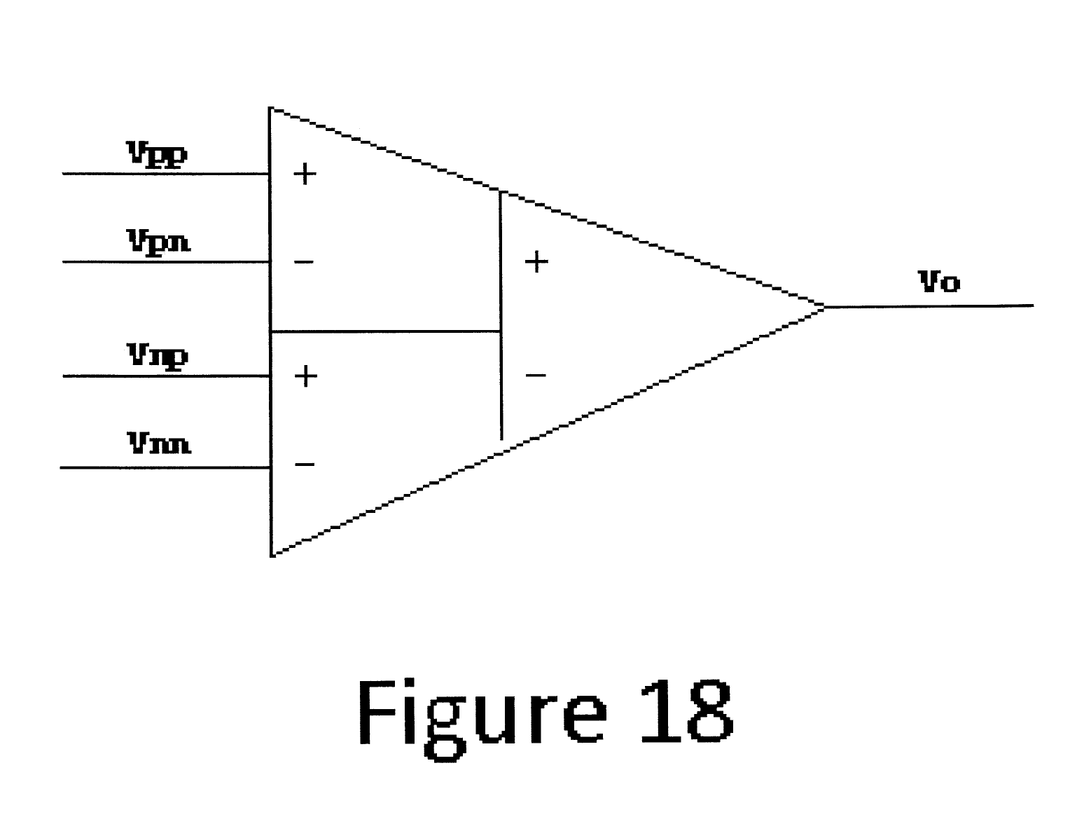

The DDA is a basic CMOS analog building block yielding simple analog circuits with low component count. The DDA is an extension to an op-amp, the main difference is that instead of two single-ended inputs, as the case in op-amps, it has two differential input ports (Vpp−Vpn) and (Vnp−Vnn). The symbol for the DDA is shown in FIG. 18. The output of a DDA can be expressed as (32)

Vₒ=Aₒ[(Vₚₚ−Vₚₙ)−(Vₙₚ−Vₙₙ)] (32)

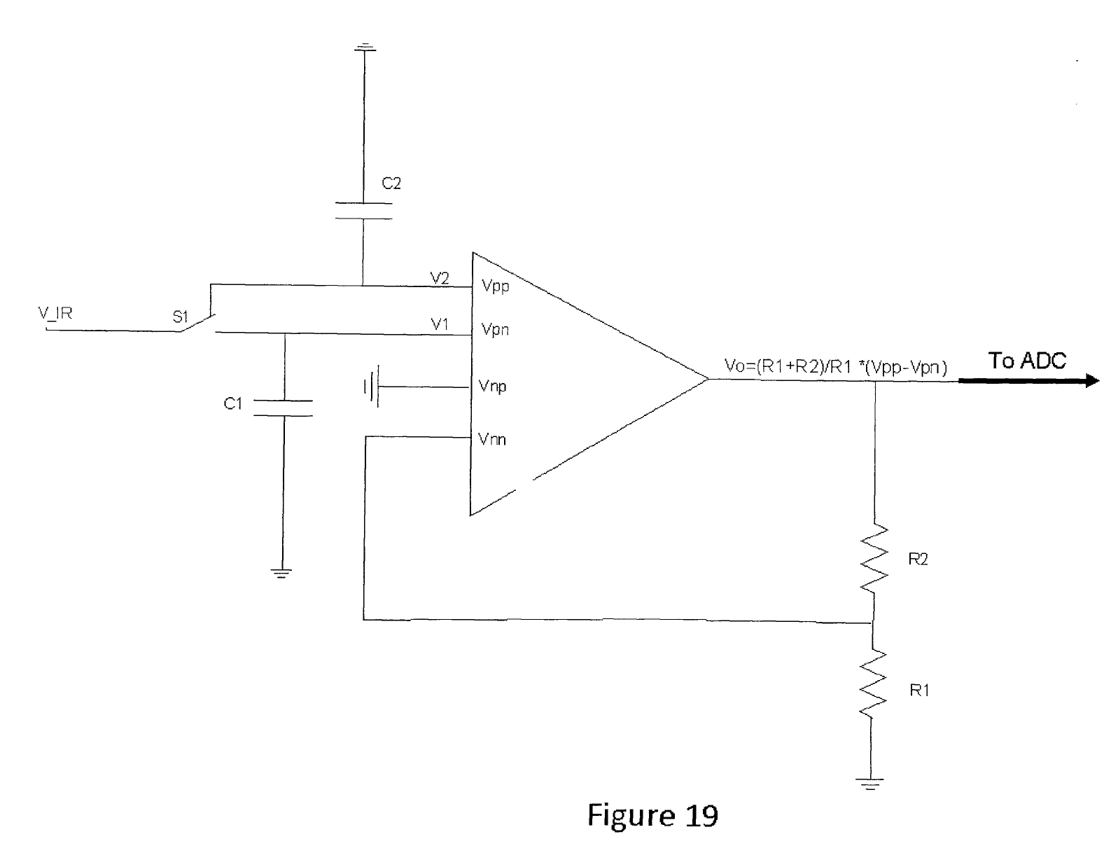

An instrumentation amplifier is well suited for amplifying the difference between two signals due to characteristics of very low DC offset, low drift, low noise, very high open-loop gain, very high common-mode rejection ratio (CMRR), and very high input impedances. But in its conventional form it requires three op-amps and many external resistors which have to be tightly matched. Mismatches in resistor values and mismatches in the common mode gains of the two input op-amps cause undesired common mode gain. An improved instrumentation amplifier can be realized using one DDA and two gain determining resistors. FIG. 19 shows a DDA realization of an instrumentation amplifier which is programmable by two external resistors for the gain of (R1+R2)/R1. The amplifier is characterized by the equation

$${V}_{o} = \frac{{R}_{1} + {R}_{2}}{{R}_{1}} ( 1 + \frac{1}{{CMRR}_{d}} + \frac{1}{2 {CMRR}_{n}} - \frac{1}{{A}_{d}} \frac{{R}_{1} + {R}_{2}}{{R}_{1}} ) ( {V}_{2} - {V}_{1} + {V}_{cm} \frac{1}{{CMRR}_{p}} + {V}_{off} ) \qquad ( 33 )$$

where CMRRₚ and CMRRₙ are the common mode rejection ratios for the two input ports p and n respectively. CMRR_{d} which is not known from the regular op-amp, measures the effect of equal floating voltages at the two input ports. A_{d} is the differential gain of V₂−V₁ while V_{cm} is the common mode voltage of the differential pair (V₂−V₁) and V_{off} is the offset voltage. It can be seen from (33) that with high differential gain and high common mode rejection ratios, accurate differential gain can be accomplished over a wide common mode input voltage range. It should also be noted that the offset voltage can be reduced using known offset cancellation techniques such as the autozero technique used in op-amps. The DDA design has very high open loop gain (A_{d}) and high common mode rejection ratios (CMRRₙ,CMRRₚ,CMRR_{d}) yielding good results for equation (33)

A basic circuit implementing the readout is shown in FIG. 19, where two capacitors C1 and C2 will store the voltage V_{IR} depending on the state of the switch S1. More advanced switched capacitor sample-and-hold circuits with charge injection cancellation can be incorporated instead of the configuration in FIG. 19, but for basic understanding of the readout procedure the configuration in FIG. 19 is shown. For every successive readout the switch toggles, connecting V_{IR} to either C1 or C2 and the DDA amplifies the difference between the voltages (V2−V1). For every readout the current voltage is stored in the capacitor with the switch closed and the other capacitor has the previous voltage stored on it, thereby amplifying only the difference between the readouts. Due to the nature of the interferogram there will not be two successive readouts with large voltage differences and therefore the DDA can be configured to have a large closed loop gain. Very small resistance differences (i.e. temperature change in the A-Si), can be detected, thereby improving the SNR and the detectivity of the CMOS-FTIR spectrometer. The output of the DDA ((R1+R2)/R1*(V2−V1)), is connected to the input of the ADC for conversion to a digital number. The output voltage can be either positive or negative depending if V2 is larger or smaller than V1. The DDA only amplifies the difference between the two readouts, therefore the polarity of the most recent output holds the information if the readout was larger or smaller than the previous voltage (i.e. depending on the state of the switch and polarity of the output it can be evaluated if the current readout needs to be added or subtracted to the previous readout). The ADC converts from the negative power supply voltage Vss to the positive power supply voltage Vdd and depending on the polarity of the input signal and the state of the switch, the digital value will be derived. The ADC structure and the basic algorithm will be discussed in the next section.

### IIX. ANALOG TO DIGITAL CONVERSION AND DIGITAL ALGORITHMS

From the previous section, one of the inputs to the ADC is the analog signal with a voltage value equal to the difference of the current readout to the previous readout times a gain factor of (R1+R2)/R1. The other inputs to the ADC are the state of switch S1 and the gain factor (R1+R2)/R1 from FIG. 19. There exist many well established topologies for analog to digital conversion in CMOS technology. Such topologies include a flash ADC, a pipeline ADC, a successive approximation ADC, a ramp compare ADC, Wilkinson ADC, integrating ADC and many more. Any ADC architecture can be used and this description only discloses the algorithm that needs to be adapted during the ADC conversion to incorporate the DDA's detectivity enhancement. The basic conversion algorithm is written logically in (34).

$$\{ \begin{matrix}+ {D}_{ADC} & ; if ( S 1 \text{:} {V}_{2} = {V}_{IR} and {V}_{0} > 0 ) or ( S 1 \text{:} {V}_{1} = {V}_{IR} and {V}_{0} < 0 ) \\ - {D}_{ADC} & ; if ( S 1 \text{:} {V}_{2} = {V}_{IR} and {V}_{0} < 0 ) or ( S 1 \text{:} {V}_{1} = {V}_{IR} and {V}_{0} > 0 )\end{matrix} \qquad ( 34 )$$

Where D_{ADC} the digital value after conversion from the ADC, the positive or negative value of D_{ADC} indicates if the digital value will be added or subtracted to the previous conversion, i.e. if the current point in the interferogram has a higher or lower value than the previous point. The sign for D_{ADC} as seen in (34) depends on the state of the switch Si and whether the output voltage is positive or negative, which can be easily evaluated with a simple comparator. For simplicity when working in the digital domain the D_{ADC} can be represented using 2-complement form and this way can be added or subtracted easily to calculate the final digital value D_{current}, evaluated through (35)

D_{current}=Dₚᵣₑᵥᵢₒᵤₛ+(D_{ADC}<<D_{Gain}_{_{—}}_{Factor}) (35)

where Dₚᵣₑᵥᵢₒᵤₛ the previous final digital value of the interferogram point being evaluated, and D_{Gain}_{_{—}}_{Factor} is the digital value of the gain factor (R1+R2)/R1 that needs to be divided to get the unity gain value, i.e.

$${2}^{{D}_{Gain \_ Factor}} = ( R 1 + R 2 ) / R 1.$$

The shift left operation (<<) in (35) is the digital division of the amplified value. The value D_{current} is stored and used for the next readout as Dₚᵣₑᵥᵢₒᵤₛ and this procedure is repeated for the full interferogram. As the whole device is incorporated in a CMOS integrated circuit the digital procedures and the storing of the data on on-chip memory are easily integrated using standard CMOS tools and fabrication methods.

The interferogram changes as a function of the voltage applied to the MZI, due to the full integration of the interferometer with the electronics on chip, and the sampling rate and the voltage can be synchronized more accurately in comparison to other FTIR spectrometers. In other FTIR spectrometers mechanical movement of the mirror and mirror's retardation speed needs to be synchronized to the sampling rate done in electronics. The need for synchronization adds a great deal of complexity (usually incorporating additional lasers to measure the mirror displacement) and leads to errors which cause decreased resolution and performance. With the disclosed CMOS-FTIR spectrometer, this is much less of an issue as only negligible delays in the voltage propagating through the interconnect to the MZI and the response time of the MZI needs to be accounted for.

Now that the interferogram has been evaluated and the digital data is stored for each sampled point, the interferogram needs to be converted into the spectral distribution information C as a function of wavelength C(λ) or wavenumber C(υ). This is done by taking the complex Fourier transform of the interferogram, shown in (36)

$$C ( λ ) = {\int }_{- {V}_{min}}^{{V}_{max}} I ( V ) exp ( - j \cdot 4 π \cdot λ \cdot V ) d V \qquad ( 36 )$$

where I(V) is the interferogram as a function of the voltage V applied to the MZI Well established digital techniques are used to perform the Fourier Transform, here the digital method of Cooley and Tukey called the Fast Fourier Transform (FFT) is used. The FFT uses the digital values stored in (35) and is easily implemented in a CMOS technology. The spectrum is then derived with the desired spectral accuracy by calculating the refractive index variations per voltage applied. Noise due to the incoherent light waves is averaged out by taking many samples which increases the SNR. When the spectrum is derived it is stored in an on-chip memory and the spectrum can be analyzed, compared and evaluated to a pre-stored database of spectrums for various referenced materials. Additional processors, digital modules, user interfaces and software such as an operating system can be integrated using standard CMOS design allowing the full control and data acquisition of the CMOS-FTIR spectrometer to be integrated on-chip.

This section concludes the disclosure of an example of the CMOS-FTIR spectrometer of this invention. The FTIR spectrometer integrated in a CMOS technology allows for integration of photonic elements with the electronics, making a more compact FTIR spectrometer. All functionality of the classical FTIR spectrometer is integrated in the CMOS chip and any additional user functions that are needed can easily be designed using standard CMOS processes and integrated on-chip. The CMOS-FTIR spectrometer is compact, can be battery operated, low cost and can be integrated with other electronic equipment and devices opening a wide range of new applications in addition to the existing applications for FTIR spectrometers today.

### IX. LONG INFRARED EXPANSION AND SINGLE LIGHT SOURCE, SINGLE INTERFEROMETER DESIGN

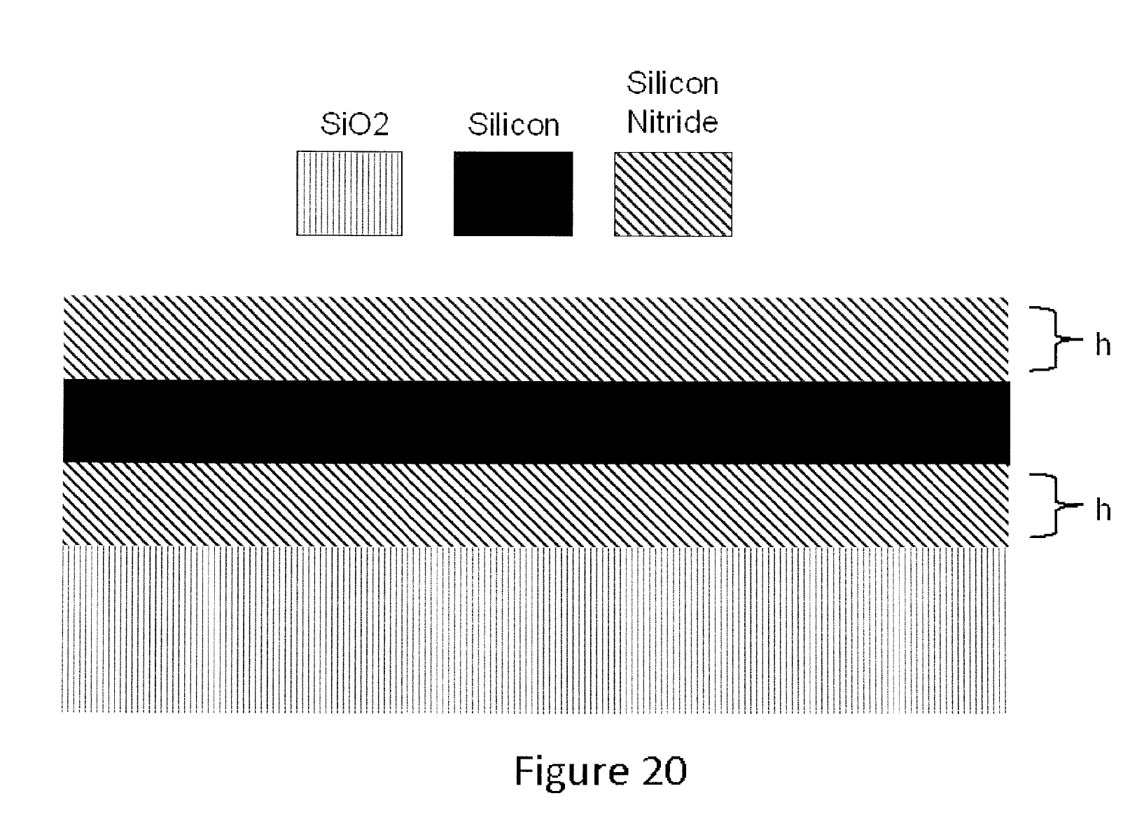

The main limiting factor for the maximum wavelength that can be incorporated in the CMOS-FTIR spectrometer is the use of silicon dioxide. Silicon is transparent between 1.4 μm to 15 μm but Si—O_{X} bonds lead to strong infrared absorption between the wavelengths of 8-10 μm. For the SOI technology the insulator is usually silicon dioxide and therefore the evanescent wave in the waveguide will get absorbed and eventually optical power for waves propagating in the waveguides will be lost. For this disclosure fabricated with a silicon dioxide wafer, the wavelengths may operate from 1.4 μm-8 μm. The CMOS-FTIR spectrometer can be expanded to work from 1.4 μm to 11 μm by using a layer of silicon nitride below and on top of the waveguides instead of silicon dioxide. Si—N_{X} bonds lead to absorption between 11 μm to 13 μm and therefore an evanescent wave traveling in silicon nitride won't get absorbed between 1.4 μm-11 μm. A cross section view of the method for the CMOS-FTIR spectrometer expansion to the long infrared region, i.e. 1.4 μm-11 μm, is shown in FIG. 20. The waveguide has a layer of silicon nitride below and if needed above (above can be left as air in some cases) the waveguide. The thickness of the silicon nitride layer h can be calculated using the penetration depth of the waveguide from equations (5)-(8) or using (15)-(16). For the sides of the waveguide the same method holds, either air or silicon nitride can be used. Some applications require infrared absorption information up to 15 μm. For working in wavelengths between 11-15 μm the same solution as shown in FIG. 20 can be used, but instead of using silicon nitride, potassium Bromide (KBr) which is transparent up to 25 μm or Barium Fluoride (BaF2) which is transparent up to 15 μm can be used. KBr and BaF2 are common materials used in infrared spectroscopy.

### X. CMOS-RAMAN SPECTROMETER

Raman spectroscopy is a technique used to study the vibrational, rotational and other low frequency modes in a system. It is similar to the FTIR spectroscopy, yields about the same results, but provides complementary information. The main difference in a Raman spectrometer is that light from a monochromatic light source, usually near infrared (NIR) laser, is used to excite the vibrational and rotational modes in the sample under test. The broadband emitted light from the sample is collected and an interferogram is generated from the Raman scattering. With regards to the disclosed invention all the components that are discussed in sections III-IV and sections VI-IX are the same for a CMOS-Raman spectrometer in accordance with this disclosure. A difference is apparent in section II where the broadband source is not needed, just a monochromatic NIR laser light as a source is used and in section V where now the sample interface is at the beginning of the design.

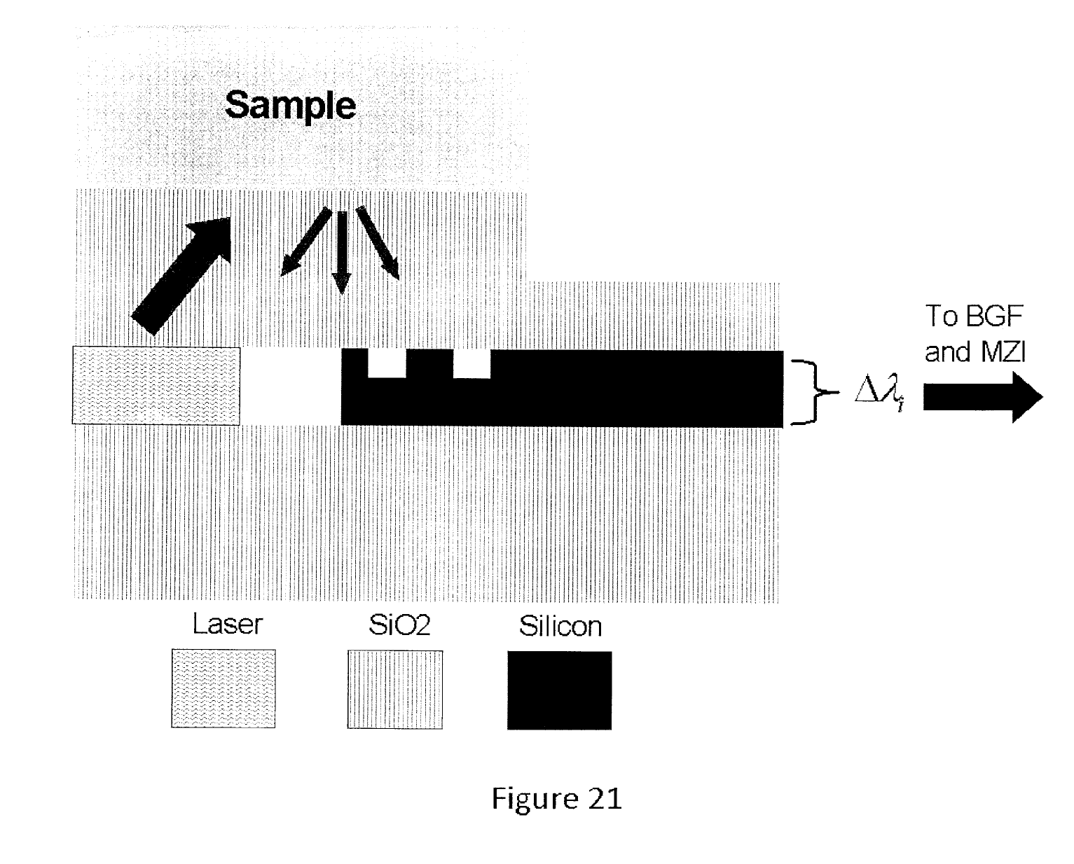

As in the CMOS-FTIR spectrometer there are still N waveguides supporting only the single mode of the wavelength span Δλ_{ᵢ}, i=1, . . . , N. The initial waveguides still have all the components disclosed in the CMOS-FTIR spectrometer, the wavelength filter and MZI and now the output of the MZI goes straight to the detector either via diffraction similar to FIG. 13 (but without the sample), or by tapering the waveguide so the light get coupled out the detector. The sample is now near the initial waveguide section and the vibrational and rotational light is excited with a monochromatic NIR laser, as shown in FIG. 21. There are many well known designs for integrated NIR lasers or LEDS and any one of them can be used for the disclosed CMOS-Raman spectrometer. In FIG. 21, a cross section view is shown of the initial waveguide for one wavelength span. An integrated laser excites the sample and it emits infrared radiation for all the broadband wavelengths. Using diffraction each waveguide will only diffract the wavelength span it supports. Rayleigh scattering is not an issue because it won't diffract into or propagate in the waveguides. Any wavelengths that are not part of the desired span will be reflected by the filter before it enters the MZI.

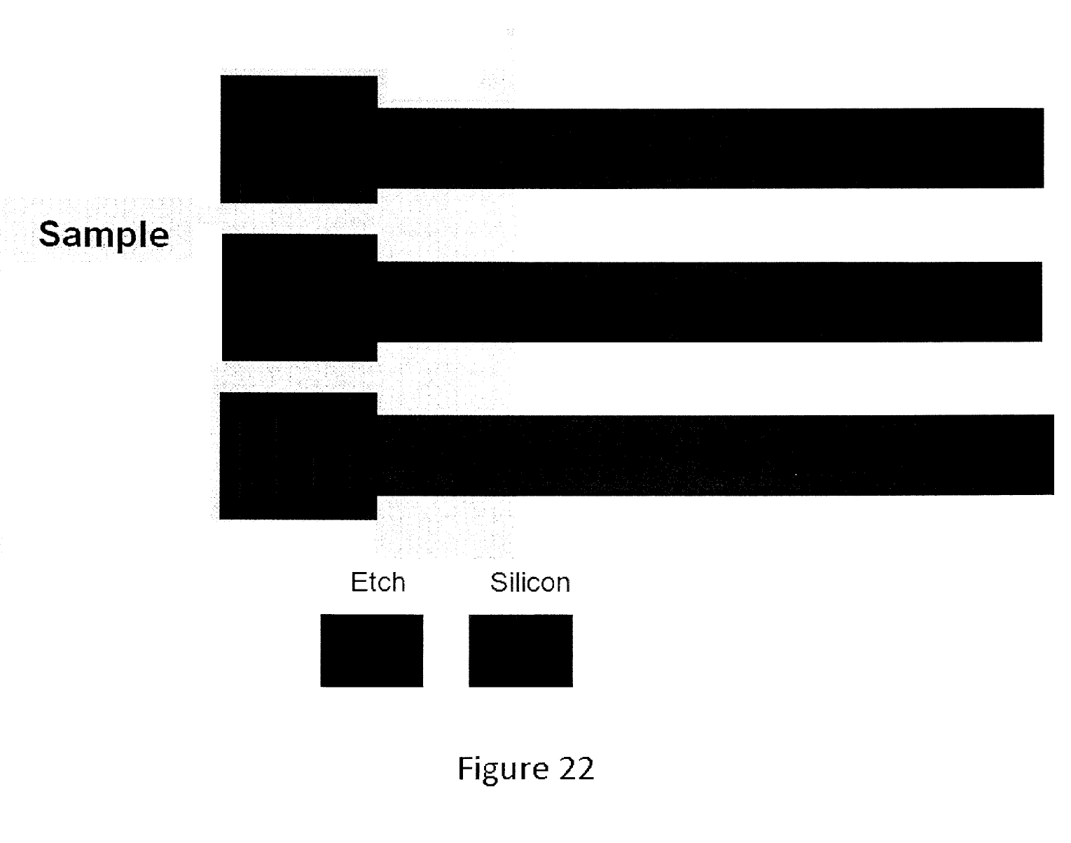

A top view of the CMOS-Raman spectrometer interface is shown in FIG. 22 for one wavelength span. The structure of FIG. 22 is repeated for the entire wavelength span, each having larger waveguide dimensions. When the light starts propagating in the waveguide, only the single mode is supported and from that point forward the disclosed CMOS-Raman spectrometer is the same as the CMOS-FTIR spectrometer.

### XI. CONCLUSION

The disclosed invention provides a method for a fully integrated CMOS-FTIR spectrometer and CMOS-Raman spectrometer. The CMOS-FTIR spectrometer has all the components of the classical FTIR spectrometer fully integrated into a compact, miniaturized, low cost CMOS-Fabrication-compatible chip. The disclosed CMOS-FTIR spectrometer can be operated in the short and mid infrared regions, i.e. from 1.4 μm to 8 μm, with available extension to the longer infrared regions, i.e. 8 μm to 15 μm. The CMOS-FTIR spectrometer disclosed has increased spectral resolution, no movable parts, no optical lenses, is compact, not prone to damage in harsh external conditions and most importantly can be fabricated with a standard CMOS technology allowing the mass production of FTIR spectrometers at low cost. The fully integrated CMOS-FTIR spectrometer is suitable for battery operation; desired functionality can be integrated on chip with standard CMOS technology thereby paving the way for new types of consumer devices in addition to existing FTIR spectrometer devices. The same disclosed invention for the FTIR spectrometer can be incorporated for a CMOS-Raman spectrometer with minor changes with regards to the design. A fully integrated CMOS-Raman spectrometer has also been disclosed.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

What is claimed is:

1. A spectrometer comprising:
(a) a broadband infrared signal divided into N wavelength spans Δλᵢ, i=1, . . . , N so that each wavelength span only propagates in its fundamental mode; and
(b) means to generate an interferogram via modulation in silicon waveguides.

2. The spectrometer of claim 1 with a broadband infrared source for the signal integrated on the same integrated circuit as the spectrometer.

3. The spectrometer of claim 1 where the generation of the interferogram via modulation is based on the thermo-optic effect of silicon.

4. The spectrometer of claim 1 where the generation of the interferogram via modulation is based on the plasma dispersion effect of silicon (Free Carrier Absorption).

5. The spectrometer of claim 1 with means to sense temperature to obtain high spectral accuracy.

6. The spectrometer of claim 1 with a sample interface integrated on chip using ATR in silicon waveguides in which the light does not leave the waveguide and is only diffracted or coupled out of the waveguide when reaching an infrared detector.

7. The spectrometer of claim 1 with a sample interface integrated on chip for external reflectance utilizing a diffraction grating to modulate the angle of light.

8. The spectrometer of claim 1 with a free-standing thermal detector microbolometer integrated on the same integrated circuit as the spectrometer.

9. The spectrometer of claim 1 implementing an algorithm involving the ADC to incorporate the DDA's sensitivity enhancement.

10. The spectrometer of claim 1 being an integrated CMOS-FTIR spectrometer.

11. The spectrometer of claim 1 being a CMOS-Raman Spectrometer.

12. The spectrometer of claim 1 made useful for longer wavelengths, up to 11 μm by using silicon nitride, and up to 15 μm by using various materials transparent to infrared wave lengths up to 15 μm.

13. A method comprising:
dividing a broadband infrared signal into N wavelength spans Δλᵢ, i=1, . . . , N so that each wavelength span only propagates in its fundamental mode; and
generating an interferogram via modulation in silicon waveguides.

14. The method of claim 13 further comprising the step of integrating a broadband infrared source for the signal on the same integrated circuit as the spectrometer.

15. The method of claim 13 further comprising the step of generating the interferogram via modulation based on the thermo-optic effect of silicon.

16. The method of claim 13 further comprising the step of generating the interferogram via modulation based on the plasma dispersion effect of silicon (Free Carrier Absorption).

17. The method of claim 13 further comprising of the step of sensing temperature to obtain high spectral accuracy.

18. The method of claim 13 further comprising a step of interaction of the signal with a sample via a sample interface integrated on chip using ATR in silicon waveguides

19. The method of claim 13 further comprising the step of interaction of the signal with a sample via a sample interface integrated on chip for external reflectance utilizing a diffraction grating to modulate the angle of light.

20. The method of claim 13 further comprising the use of a free-standing thermal detector microbolometer integrated on the same integrated circuit as the spectrometer for sensing temperature.

21. The method of claim 13 further comprising the implementation of an algorithm involving the ADC to incorporate the DDA's sensitivity enhancement in the generation of a result from the interferogram

22. The method of claim 13 further comprising the use of an integrated CMOS-FTIR spectrometer.

23. The method of claim 13 further comprising the use of a CMOS-Raman Spectrometer.

24. The method of claim 13 further utilizing silver nitride in the spectrometer of longer wavelengths, up to, and using various materials transparent to infrared wave lengths up to 15 μm for longer wavelengths, up to 15 μm.
